(19) United States
(12) Patent Application Publication
(10) Pub. No.: US 2025/0312934 A1
(43) Pub. Date: Oct. 9, 2025

(54) FRICTION FIT HANDLE CLIPS, HAIR CUTTING DEVICES, AND RELATED APPARATUSES AND METHODS OF USE

(71) Applicant: BAKSCAPE HOLDING CORP., Edmonton (CA)

(72) Inventor: Martin S. Niles, Edmonton (CA)

(21) Appl. No.: 18/865,290

(22) PCT Filed: May 11, 2023
(86) PCT No.: PCT/CA2023/050652

§ 371 Date: Nov. 12, 2024

Related U.S. Application Data
(60) Provisional application No. 63/340,847, filed on May 11, 2022.

(51) Int. Cl. B26B 19/14; B26B 19/38

(52) U.S. Cl. CPC B26B 19/148; B26B 19/3853

(57) ABSTRACT

A hair cutting device, has a hair cutting part with a palm knob and a multi-directional motorized blade, the hair cutting part being shaped, in a direction from a palm grip top end to a hair cutting base end of the hair cutting part, to narrow at a base part of the palm knob to define or connect to a neck and then widen at a base part of or along the neck to the multi-directional motorized blade, the multi-directional motorized blade being configured to cut hair while being advanced in any direction of skin travel within a 360-degree range of direction of skin travel; and a handle part with an elongate shaft and a reversible connector at a head end of the elongate shaft, to permit a user to remotely manipulate the hair cutting part into contact with all areas of a user.

### TECHNICAL FIELD

This document relates to hair cutting devices, including leg and back hair cutting devices, and related methods of use.

### BACKGROUND

A conventional handheld hair and body shaving device, such as a pair of clippers, may be used to shave the hair of a user. Common shaving devices often incorporate a static and reciprocating blade arranged to permit the device to travel over a skin surface in a single direction or along an axis that includes forward and backward directions. A short, integral handle may extend from the blade head, particularly in the case of handheld beard shaving devices and head hair clippers, to permit a user to grip the device at a position closely adjacent the head to make skillful cutting maneuvers. Difficult to reach areas of the body may be accessed by employing a second person to operate the shaving device. Back and body hair cutting devices may incorporate an elongate handle to mount a multi-directional motorized blade, such as shown in the inventor's prior U.S. patent publication number 2020/0130206.

### SUMMARY

A hair cutting device is disclosed comprising: a hair cutting part; and an elongate handle part, which may be sized to permit a user to remotely manipulate the hair cutting part into contact with all areas of the body of the user.

A hair cutting device is disclosed for a hair cutting part, the hair cutting part having a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, the multi-directional motorized blade being configured to cut hair while being advanced in any direction of skin travel within a 360-degree range of direction of skin travel, the body hair cutting device comprising: a handle part with an elongate member and a reversible connector on the elongate member, the handle part being sized to permit a user to remotely manipulate the hair cutting part in use into contact with all areas of a back and legs of the user; and the reversible connector having a base pincer claw and a top pincer claw collectively shaped and structured to grip in use both the base part and a palm grip top surface, respectively, of the palm knob to at least partially enclose the palm knob within a palm-knob-receiving cavity defined between the base and top pincer claws, with the neck received in use within a neck opening defined in the base pincer claw.

A method is disclosed comprising operating a handle part to manipulate a hair cutting part into contact with a user, in which: the hair cutting part has a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, in which during operating the multi-directional motorized blade cuts hair while being advanced in any direction of skin travel within a 360-degree range of direction of skin travel; and the handle part has an elongate member and a reversible connector on the elongate member, in which during operating the handle part permits the user to remotely manipulate the hair cutting part into contact with all areas of a back and legs of the user; and the reversible connector having a base pincer claw and a top pincer claw collectively shaped and structured to grip both the base part and a palm grip top surface, respectively, of the palm knob, to at least partially enclose the palm knob within a palm-knob-receiving cavity defined between the base and top pincer claws, with the neck received within a neck opening defined in the base pincer claw.

A hair cutting device is disclosed comprising: a hair cutting part with a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, the multi-directional motorized blade being configured to cut hair while being advanced in any direction of skin travel within a 360-degree range of direction of skin travel; and a handle part with an elongate member and a reversible connector on the elongate member, the handle part being sized to permit a user to remotely manipulate the hair cutting part into contact with all areas of a back and legs of the user; and the reversible connector having a base pincer claw and a top pincer claw collectively shaped and structured to grip both the base part and a palm grip top surface, respectively, of the palm knob to at least partially enclose the palm knob within a palm-knob-receiving cavity defined between the base and top pincer claws, with the neck received within a neck opening defined in the base pincer claw.

A method is disclosed comprising operating a handle part to manipulate a hair cutting part into contact with a user, in which: the hair cutting part has a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, in which during operating the multi-directional motorized blade cuts hair while being advanced in any direction of skin travel within a 360-degree range of direction of skin travel; and the handle part has an elongate member and a reversible connector on the elongate member, in which during operating the handle part permits the user to remotely manipulate the hair cutting part into contact with all areas of a back and legs of the user; and the reversible connector having a base pincer claw and a top pincer claw collectively shaped and structured to grip both the base part and a palm grip top surface, respectively, of the palm knob, to at least partially enclose the palm knob within a palm-knob-receiving cavity defined between the base and top pincer claws, with the neck received within a neck slot defined in the base pincer claw.

A hair cutting device is also disclosed comprising: a hair cutting part with a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, the multi-directional motorized blade being configured to cut hair while being advanced in any direction of skin travel within a 360-degree range of direction of skin travel; and a handle part with an elongate member and a reversible connector on the elongate member, the handle part being sized to permit a user to remotely manipulate the hair cutting part into contact with all areas of a back and legs of the user; and the reversible connector having pincer claws collectively shaped and structured to friction fit to the palm knob to at least partially enclose the palm knob within a palm-knob-receiving cavity defined between the pincer claws, in which a rear part of the palm-knob-receiving cavity is shaped to conform to a rear part of the palm knob to form the friction fit therebetween.

A method is also disclosed comprising operating a handle part to manipulate a hair cutting part into contact with a user, in which: the hair cutting part has a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, in which during operating the multi-directional motorized blade cuts hair while being advanced in any direction of skin travel within a 360-degree range of direction of skin travel; and the handle part has an elongate member and a reversible connector on the elongate member, in which during operating the handle part permits the user to remotely manipulate the hair cutting part into contact with all areas of a back and legs of the user; and the reversible connector having pincer claws collectively shaped and structured to friction fit to the palm knob to at least partially enclose the palm knob within a palm-knob-receiving cavity defined between the pincer claws, in which a rear part of the palm-knob-receiving cavity is shaped to conform to a rear part of the palm knob to form the friction fit therebetween.

A hair cutting device is disclosed comprising: a hair cutting part with a palm knob, a neck extended from a base of the palm knob, and a multi-directional motorized blade mounted on the neck and configured to cut hair while being advanced in any direction of skin travel within a 360 degree range of direction of skin travel; and a handle part with an elongate shaft, and a reversible connector at a head end of the elongate shaft, the reversible connector comprising a set of opposed claws separated to define a mouth and a palm-knob-receiving cavity within which the palm knob is reversibly retained, with a base claw of the set of opposed claws defining a neck-receiving slot within which the neck is retained, and with a top claw of the set of opposed claws overlying a top palm grip of the palm knob and cooperating with the base claw to latch and retain the palm knob within the palm-knob-receiving cavity.

A hair cutting device is disclosed comprising: a hair cutting part that has a blade that is structured to define a plurality of directions of skin travel, including forward and lateral directions of skin travel, and configured to cut hair when advanced over a skin surface in each of the plurality of directions of skin travel; and an elongate handle part sized to permit a user to remotely manipulate the hair cutting part into contact with all areas of a back of the user.

A method is disclosed comprising: operating an elongate handle part to manipulate a hair cutting part into contact with the user.

In various embodiments, there may be included any one or more of the following features: respective terminal front tips of the base and top pincer claws are spaced to define a palm-knob-receiving mouth defining a lateral entry axis for the hair cutting part to enter and exit the palm-knob-receiving cavity. A respective terminal front tip of the base pincer claw and a respective terminal front tip of the top pincer claw curl inward toward one another to retain a front part of the palm knob between the respective front tips and a rear end of the palm-knob-receiving cavity. The respective terminal front tip of the base pincer claw and the respective terminal front tip of the top pincer claw collectively form a C-shape in cross-section. The reversible connector is structured to snap fit to and quick release from the palm knob. One or both of the base pincer claw and the top pincer claw form resilient cantilever snap fits. The reversible connector is structured to friction fit to the palm knob. A rear part of the palm-knob-receiving cavity is shaped to conform to a rear part of the palm knob to form the friction fit therebetween. The rear part of the palm knob and the rear part of the palm-knob-receiving cavity define cooperating male and female key parts that engage when the palm knob is within the palm-knob-receiving cavity. The rear part of the palm knob is tapered to have decreasing lateral dimensions with decreasing distance to a rear end of the palm knob, and the rear part of the palm-knob-receiving cavity that conforms to the rear part of the palm knob is tapered to have increasing lateral dimensions with increasing distance from the rear end of the palm-knob-receiving cavity. One or both of the base pincer claw and top pincer claw have opposed side edges that curl inward toward one another to retain opposed sides of the palm knob within the palm-knob-receiving cavity. Both of the base pincer claw and top pincer claw have opposed side edges that curl inward. The base pincer claw and the top pincer claw define a base cupping member and a top cupping member, respectively, that collectively define the palm-knob-receiving cavity. The base pincer claw comprises opposed side fingers that are separated laterally to define the neck opening as a neck slot, and whose respective finger tips are separated to define a neck-receiving mouth to the neck slot. The neck opening is structured to encircle and form a closed path about the neck in use. The base pincer claw is structured to grip the neck about the neck opening. Opposed sets of side edges of each of the base and top pincer claws are separated between the base and top pincer claws to define finger access slots to opposed sides of the palm knob. The elongate member mounts or contains a balancing weight part that has a relatively higher weight density than the elongate member. The hair cutting part forms part of the hair cutting device, with the palm knob at least partially enclosed within the palm-knob-receiving cavity. The multi-directional motorized blade is connected to pivot relative to one or more of the neck, the palm knob, or the handle part. The elongate member comprises an elongate shaft with the reversible connector mounted at a head end of the elongate shaft. The elongate shaft has a length of at least one foot. Operating the body hair cutting device to cut hair on a body of a user. Connecting the hair cutting part to the reversible connector by inserting the palm knob through a palm-knob-receiving mouth defined by the base and top pincer claws into the palm-knob-receiving cavity. Disconnecting the hair cutting part from the reversible connector by removing the palm knob through the palm-knob-receiving mouth defined by the base and top pincer claws into the palm-knob-receiving cavity. Connecting comprises latching the base and top pincer claws to the palm knob by snap fit. Connecting the base and top pincer claws to the palm knob by friction fit. Disconnecting the hair cutting part to the reversible connector by opening the base and top pincer claws and retracting the palm knob through the palm-knob-receiving mouth from the palm-knob-receiving cavity. Disconnecting comprises retracting the palm knob through the palm-knob-receiving mouth from the palm-knob-receiving cavity with a force that is greater than a force required to insert the palm knob through the palm-knob-receiving mouth into gripping contact with the palm-knob-receiving cavity. The hair cutting part has a lock to retain the palm knob within the palm-knob-receiving cavity. The reversible connector is structured to resiliently move between an open position and a closed position, and is biased into the closed position, with the base and top pincer claws covering and gripping the palm knob in the closed position, and the base and top pincer claws spread relatively apart from each other in the open position to permit release of the palm knob from the palm-knob-receiving cavity. Each of the opposed side edges of one or both the base pincer claw and the top pincer claw form resilient cantilever snap fits. Operating comprises cutting hair in a handheld mode where the user grips the hair cutting part with the user's hand. Operating comprises an extension mode in which the elongate handle part grips the hair cutting part. Connecting the elongate handle part to the hair cutting part by either: threading the elongate handle part to the hair cutting part; or connecting a split ring, of the elongate handle part, to the hair cutting part. The elongate member comprises a sling. The hair cutting part is connected to the sling at an intermediate position between opposed handle ends of the sling. The hair cutting part is connected to head (hair cutter) ends of a pair of slings. Operating comprises gripping the opposed tail (handle) ends with respective hands of the user. Operating comprises pivoting the handle part relative to the hair cutting part. Operating the handle part to manipulate a hair cutting part into contact with a back of the user, in which the hair cutting part has a blade that is configured to cut hair while being advanced in any direction of skin travel within a range of at least 90 degrees, 180 degrees, 270 degrees, or 360 degrees.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a handle part with a reversible connector for clipping to a hair cutting part. FIG. 2 is a top plan view of the handle part with reversible connector of FIG. 1. FIG. 3 is a bottom plan view of the handle part with reversible connector of FIG. 1. FIG. 4 is a front-end view of the handle part with reversible connector of FIG. 1. FIG. 5 is a side elevation view of the handle part with reversible connector of FIG. 1 connected to a hair cutting part. FIG. 6 is a top plan view of the handle part and hair cutting part combination of FIG. 5. FIG. 7 is a section view taken along the 7-7 sections lines in FIG. 6, with the terminal front tips of the top and base pincer claws both shown in the closed position (solid lines) and open position (dashed lines). FIG. 8 is a section view taken along the 7-7 section lines in FIG. 6, with the elongate handle part omitted, and the position of a user's hand and thumb shown in dashed lines, to illustrate a handheld mode of operation of the hair cutting part. FIG. 9 is an exploded view of the handle part and hair cutting part combination of FIG. 5. FIG. 10 is a section view taken along the 9-9 section lines in FIG. 6. FIG. 11 is perspective view of another embodiment of a handle part with a reversible connector for clipping to a hair cutting part. FIG. 12 is a bottom plan view of the handle part with a reversible connector of FIG. 11. FIG. 13 is a side elevation view of the handle part with a reversible connector of FIG. 11. FIG. 14 is a rear end view of the handle part with a reversible connector of FIG. 11. FIG. 15 is a front-end view of the handle part with a reversible connector of FIG. 11. FIG. 16 is a perspective view illustrating the combination of a handle part and hair cutting part of FIG. 5 being used to cut hair on the leg of a user FIG. 17 is a perspective view illustrating the combination of a handle part and hair cutting part of FIG. 5 being used to cut hair on a back of a user. FIG. 18 is a perspective view of another embodiment of a handle part with a reversible connector for clipping to a hair cutting part, connected to a hair cutting part. FIG. 19 is a front-end view of the handle part and hair cutting part combination of FIG. 18. FIG. 20 is a side elevation view of the handle part and hair cutting part combination of FIG. 18. FIG. 21 is a front-end view of the handle part with reversible connector of FIG. 18. FIG. 22 is an exploded bottom plan view of the handle part and hair cutting part combination of FIG. 18. FIG. 23 is a rear end view of the handle part and hair cutting part combination of FIG. 18. FIG. 24 is a perspective view of a handle part with a fourth embodiment of a reversible connector for clipping to a hair cutting part, connected to a hair cutting part. FIG. 25 is a front-end view of the handle part and hair cutting part combination of FIG. 24. FIG. 26 is a side elevation view of the handle part and hair cutting part combination of FIG. 24. FIG. 27 is a front-end view of the handle part with reversible connector of FIG. 24. FIG. 28 is a top plan view of the handle part with reversible connector of FIG. 24. FIG. 29 is a rear end view of the handle part and hair cutting part combination of FIG. 24. FIG. 30 is a perspective view of a handle part with an eyelet. FIG. 31 is a perspective view of a reversible connector for a hair cutting part, illustrating part of opposed sling handles connected on both sides of the reversible connector, with sling connector parts shown in dashed lines. FIG. 32 is a rear elevation view of the reversible connector of FIG. 31. FIG. 33 is a top plan view of the reversible connector of FIG. 31. FIG. 34 is a side elevation view of the reversible connector of FIG. 31. FIG. 35 is a front-end elevation view of the reversible connector of FIG. 31. FIG. 36 is a top plan view of the reversible connector and sling of FIG. 31. FIG. 37 is a perspective view of a further embodiment of a handle part with a reversible connector for clipping to a hair cutting part, in which the handle part and reversible connector are formed of halves (or other shaped parts) that can be combined to provide the complete unit. FIG. 38 is a bottom plan view of the handle part with reversible connector of FIG. 37. FIG. 39 is a top plan view of the handle part with reversible connector combination of FIG. 37. FIG. 40 is a side elevation view of the handle part with reversible connector combination of FIG. 37. FIG. 41 is a front-end view elevation view of the handle part with reversible connector of FIG. 37. FIG. 42 is an exploded perspective view of the handle part with reversible connector of FIG. 37. FIG. 43 is an exploded perspective view of the handle part with reversible connector of FIG. 37. FIG. 44 is a front perspective view of an embodiment of a handle part comprising a hinge, and a reversible connector, the reversible connector being separable from the handle part and the handle part being foldable (switchable) between stowed and deployed modes. FIG. 45 is a rear perspective view of the handle part with reversible connector of FIG. 44. FIG. 46 is a side elevation view of the handle part with reversible connector of FIG. 44. FIG. 47 is a section view taken along the 47-47 section lines of FIG. 46. FIG. 48 is a side elevation view of the handle part with reversible connector of FIG. 44, with the handle part in the stowed folded mode. FIG. 49 is a top plan view of the handle part with reversible connector of FIG. 44. FIG. 50 is a bottom plan view of the handle part with reversible connector of FIG. 44. FIG. 51 is a front-end view of the handle part with reversible connector of FIG. 44. FIG. 52 is an exploded front perspective view of the handle part with reversible connector of FIG. 44. FIG. 53 is a rear end view of the handle part with reversible connector of FIG. 44. FIG. 54 is a section view taken along the 54-54 section lines of FIG. 46. FIG. 55 is a close-up view of the circular area denoted by dashed lines in FIG. 54. FIG. 56 is a section view taken along the 56-56 section lines of FIG. 46. FIG. 57 is a section view taken along the 57-57 section lines of FIG. 46. FIG. 58 is a section view taken along the 58-58 section lines of FIG. 46. FIG. 59 is a section view taken along the 59-59 section lines of FIG. 46. FIG. 60 is a section view taken along the 60-60 section lines of FIG. 49. FIG. 61 is a close-up view of the circular area denoted by dashed lines in FIG. 60. FIG. 62 is a section view taken along the 62-62 section lines of FIG. 50. FIG. 63 is a close-up view of the circular area denoted by dashed lines in FIG. 62. FIG. 64 is a front perspective view of a head part of another embodiment of a handle part with reversible connector that can fit with the tail part of the handle part of FIG. 52. FIG. 65 is a side elevation view of the head part of FIG. 64. FIG. 66 is a bottom plan view of the head part of FIG. 64. FIG. 67 is a top plan view of the head part of FIG. 64. FIG. 68 is a rear end view of the head part of FIG. 64. FIG. 69 is a front end view of the top part of the handle part with reversible connector of FIG. 64. FIG. 70 is a perspective view of a retaining part of the head part of the handle part of FIG. 52. FIG. 71 is a top plan view of the retaining part of the head part of FIG. 70. FIG. 72 is a bottom plan view of the retaining part of the head part of FIG. 70. FIG. 73 is a front-end view of the retaining part of the head part of FIG. 70. FIG. 74 is a side elevation view of the retaining part of the head part of FIG. 70. FIGS. 75 and 76 are front and rear end-views of a further embodiment of a hair cutting device with a balancing-weight compartment. FIG. 75A is a section view of a male and female key connection between palm knob and reversible connector, from the hair cutting device of FIG. 75. FIGS. 77-79 are perspective, top plan, and bottom plan, respectively, views of the hair cutting device of FIG. 75. FIG. 80 is a perspective view of an elongate handle of the hair cutting device of FIG. 75 structured to detach from the reversible connector of the device of FIG. 75. FIG. 81 is a close up perspective view of a connector between the elongate handle and reversible connector in the embodiment of FIG. 80. FIG. 82 is a bottom plan view of the elongate handle of FIG. 80.

### DETAILED DESCRIPTION

Immaterial modifications may be made to the embodiments described here without departing from what is covered by the claims.

Unwanted body hair may be removed via a variety of suitable methods, the most common of which include depilation and epilation. Depilation refers to the removal of the part of the hair above the surface of the skin, leaving the root intact under the skin. Common physical forms of depilation include cutting, which includes trimming, clipping, and shaving, for example via static methods such as with a traditional blade tool or scissors, or via motorized methods such as with an electric shaver. Chemical depilatories may be used to dissolve or weaken hair by breaking disulfide bonds that link protein chains of hair. Depilatories may take the form of creams or powders, and may be used alone or in combination with mechanical depilation methods. Depilation may also involve buffing away hair via a friction pad or other device that incorporates a rough sandpaper texture.

Epilation refers to the removal of the entire hair from the root. Epilation methods may involve one or more of tweezing, waxing, sugaring, threading, or electrology. A suitable epilation device may be used such as a laser or other pulsed light source. Epilation chemicals may be used such as thanaka powder or hair development inhibiting drugs. Epilation and depilation methods may be combined in a hair removal treatment. Hair removal methods including epilation and depilation methods may require the assistance of trained and/or licensed professionals, assistants, and other personnel, particularly when the target hair-covered area is difficult for the user him or herself to reach unaided.

A common consumer depilation device is an electrically-powered hair clipper/shaver, which may comprise an electric motor, a movable blade that is caused to move (for example rotate or oscillate) by output from the motor, and a stationary blade (or a second movable blade) that is positioned adjacent to the movable blade so that, together, the blades cut hair by shearing action. An electric hair cutting device may have a straight, single or dual cutting blade assembly where each blade includes a linear fixed cutter and a linear movable cutter, each defining a leading edge or cutting profile that collectively define a single direction of skin travel. Some hair cutting devices are able to cut in plural directions, such as rotary electric razors. An electric hair cutting device may comprise an electric motor and a power source, for example an electrical power source. The power source may be a portable power source, for example a battery, or a power cable may be used to plug the device into a wall-mounted A/C outlet to receive power. A rechargeable battery may be used. An electric razor, such as a beard shaver, may have foil or rotary cutters, which may come in multi-cutter head arrangements.

Electric shaver/razors are cutting devices with an electrically powered rotating or oscillating blade. The electric shaver usually does not require the use of shaving cream, soap, or water, although models exist that permit wet, dry, or wet and dry operation. The shaver may be powered by a small DC motor, which is either powered by batteries or mains electricity. Many modern electric shavers are powered using rechargeable batteries. Alternatively, an electro-mechanical oscillator driven by an AC-energized solenoid may be used. Some very early mechanical shavers had no electric motor and had to be powered by hand, for example by pulling a cord to drive a flywheel. Electric shavers generally fall into two main categories: foil or rotary-style, although other varieties exist including oscillating open ring designs such as the EVEN CUT™ model by CONAIR™. Many modern shavers are cordless in that such are charged up with a plug charger or placed within a cleaning and charging unit when not in use.

A foil shaver may use a foil screen or micro foil that is a thin, perforated metal screen that covers the blades of the razor. Foil shavers use sharp reciprocating or oscillating blades that move sideways behind a protective screen, shearing and cutting hairs that poke through the perforated foil screen. Foil shavers may incorporate one or more foils and may include specialized cutting elements such as trimmers, and may incorporate plural individual cutters. Foil shavers may incorporate separators between the blades and that can include foils or cassettes. A classic foil shaver design incorporates a rectangular block shaver head and cuts in only one plane.

Rotary foil shavers operate similar to classical unidirectional foil shavers but may have multiple circular heads for multi-directional cutting. As a result, a rotary shaver is often operated in a circular motion rather than a linear motion as is used with a foil shaver. Rotary shavers may have flexible heads on a rigid unit or may include a plurality of cutting heads mounted on a shaver body and include a pivoting neck connecting the rotary cutting heads and the body of the shaver. Rotary shavers have the advantage of ease of use when navigating tight contours of the body like around the nose, knees and ankles. Rotary and foil shavers may incorporate flexible heads that may adjust in response to skin pressure during use.

Multidirectional shavers are shavers where the shaver head is able to cut in more than one direction relative to the shaver head. A common design incorporates multiple rotary cutting heads that pivot relative to the base or handle of the shaver. There are different multidirectional rotary shavers on the market including the CONAIR EVEN CUT™, the Remington Balder Rotary Head Shaver™, and the Remington Ultimate Series Pure Confidence Lady Shaver™. The CONAIR EVEN CUT™ design comprises an open blade rotary cutting system with guide combs that allow the user to adjust and control the closeness of the cut. The EVEN CUT™ features a large open circular blade that permits a user to cut hair in all directions in a cutting plane defined by a base of the hair cutter. The Remington Balder Pro Rotary Head Shaver™ comprises five dual track individual rotary shaver heads that pivot and flex in a multitude of directions to allow for a multidirectional shave. The Remington Ultimate Series Pure Confidence Lady Shaver™ comprises three rotary shaver heads that flex and a neck that pivots 360 degrees allowing for constant contact between the skin and the rotary cutting heads during use. Both of the Remington™ devices are rotary shavers designed to fit in the palm of the user's hand.

Referring to FIGS. 5-9, a palm-held multi-directional motorized shaver (hair cutting part 22) is illustrated, similar to the Remington Ultimate Series Pure Confidence Lady Shaver™, but with seven rotary cutters (i.e., shaving heads, although any number of cutters may be used). The hair cutting part 22 may comprise a palm knob 88 and a multi-directional motorized blade 30. The hair cutting part 22 may be shaped to narrow (when viewed moving in a direction from a palm grip top end 22A to a hair cutting base end 22B of the hair cutting part 22) at a base part surface 88E of the palm knob 88 to define, for example integrally form or connect to, a neck 24. In some cases, the neck 24 depends from the base part surface 88E, and in some cases such as shown the neck 24 is defined at least in part by the base part surface 88E, for example as the part of the lower part of the knob 88 that narrows, from a top end 24A of the neck 24 to a base end 24B of the neck 24. The hair cutting part 22 may widen (when viewed in a direction from palm grip top end 22A toward the hair cutting base end 22B) at base part, for example base end 24B of the neck 24 to the multi-directional motorized blade 30. Referring to FIG. 7, the blade 30 may mount to the palm knob 88 via a suitable mechanism, such as view a stem 114, for example of the blade 30, and that may be received by a corresponding stem receiver 116, for example of the palm knob 88. The stem 114 may or may not form part of or the entirety of the neck 24 as defined in this document. The multi-directional motorized blade 30 may be configured to cut hair while being advanced in any direction of skin travel within a 360-degree range of direction of skin travel.

Referring to FIGS. 5-10, the palm knob 88 may be a handheld device that is structured to fit in the palm of the user's hand and be operated in a handheld mode. The palm knob 88 may define a palm grip surface at palm grip top end surface 88A. The palm knob 88 may have one or more side grip surfaces, such as side grip surfaces 88D on opposed sides of the palm knob 88. Grip surfaces may be textured or otherwise structured to improve friction with a user's fingers relative to a smooth polished surface to facilitate manual operation of the hair cutting part 22 by a user's hand on the palm knob 88. The neck 24 of the hair cutting part 22 may define a finger receiving zone or recess 32 between the blade 30 and palm knob 88, and thus, in some cases the knob 88 is shaped to receive a palm of a user against the palm grip top end surface 88A, with the user's fingers surround and enclose the palm knob 88, extending into contact with the neck 24 in the finger receiving recess 32 of the hair cutting part 22. Referring to FIGS. 5-10, the palm knob 88 may also have front and rear end surfaces 88B and 88C, respectively, in addition to surfaces 88E, 88A and 88D. The palm knob 88 may have a suitable shape, such as a bulbous shape sized to fit within the palm of a user, such as the palm of an average-sized male or female adult hand. Surfaces of the palm knob 88 may be concave to fit within the user's hand. Referring to FIG. 8, the hair cutting part 22 may be used in a handheld mode where the user directly grips the knob 88 with the user's hand (not shown) with or without the elongate handle part 12 present. While in the handheld mode the user's hand 118 may securely hold the palm knob 88, for example with a palm 118A covering the palm grip top end surface 88A, the fingers, such as index, middle, ring and/or pinky fingers 118B, encircling the palm knob 88 and gripping the finger receiving recess 32, and the thumb 118C gripping resting against the side surfaces 88D or recess 32.

Referring to FIGS. 5-10 the hair cutting part 22 may have suitable features. A power supply port 90 may be structured in the palm knob 88 or elsewhere on the hair cutting part 22 to provide a power connector to connect to a power cable from a wall outlet or other external power supply (not shown). Referring to FIG. 10, the palm knob 88 may form a housing for internal mechanical components of the hair cutting part 22, such as one or more of a motor 94, a power source 92, such as a battery, and a drive stem 98A. Hair cutting part 22 may be adapted to shave in up to 360 degrees of direction, for example in a plane 106 defined by the end 22B of the hair cutting part 22, representing the plane of cutting contact in use with the skin surface of the user during use. Hair cutting part 22 may be structured to swivel in any direction. Connecting includes securing and vice versa. A single bladed embodiment may be used, as may be embodiments with two or more blades. An embodiment may be used where two reciprocating, oscillating, or otherwise movable blades cooperate to create a shearing action.

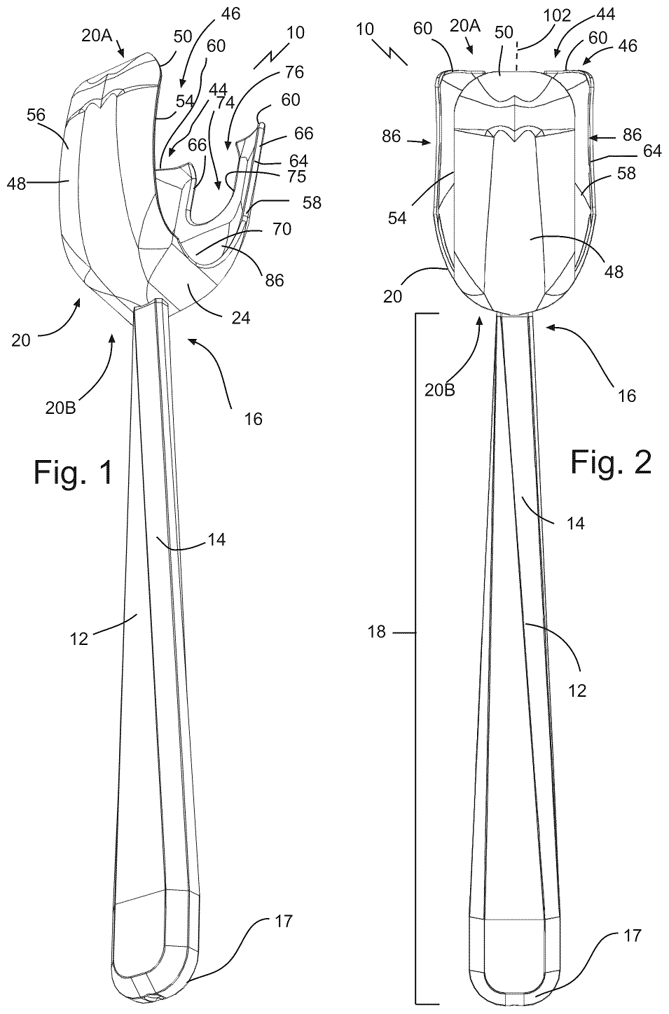

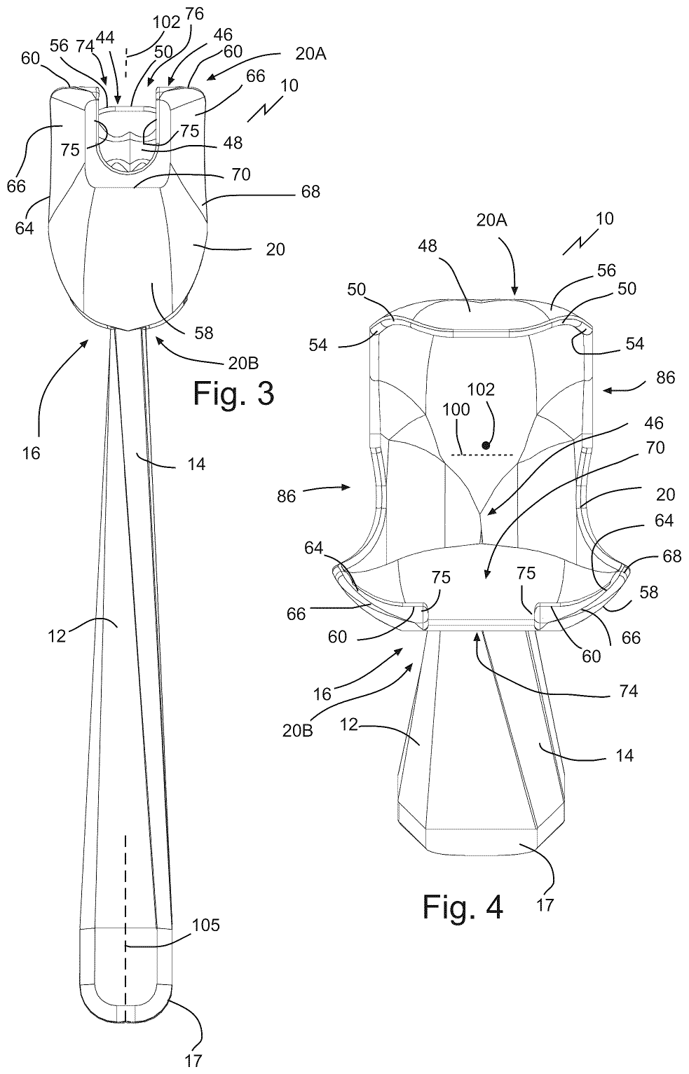

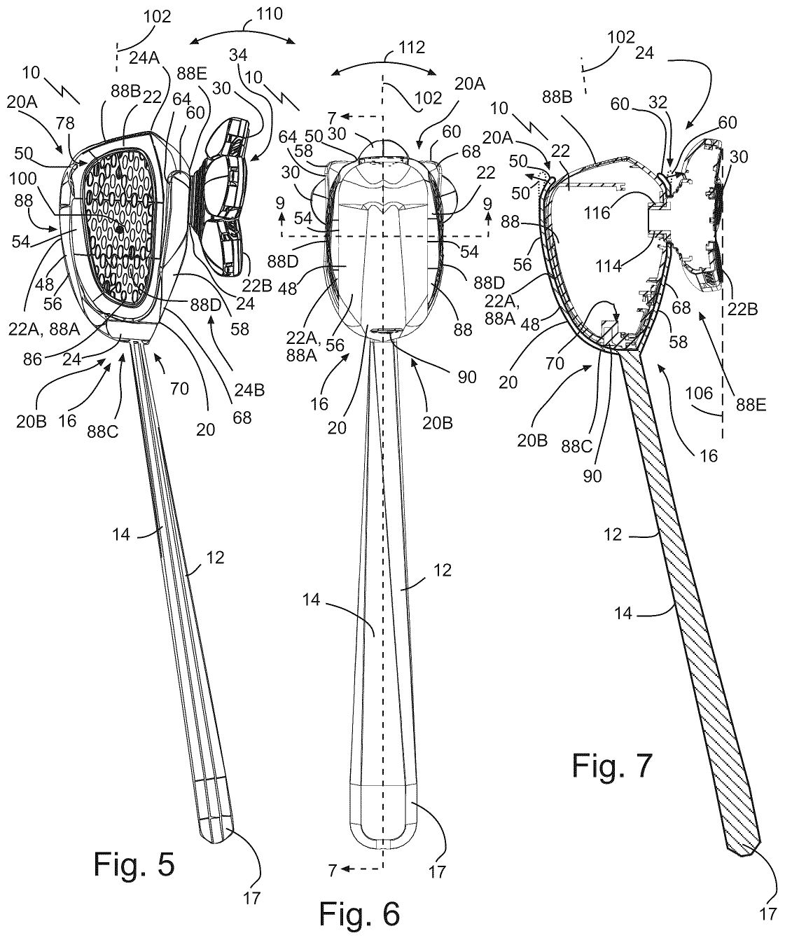

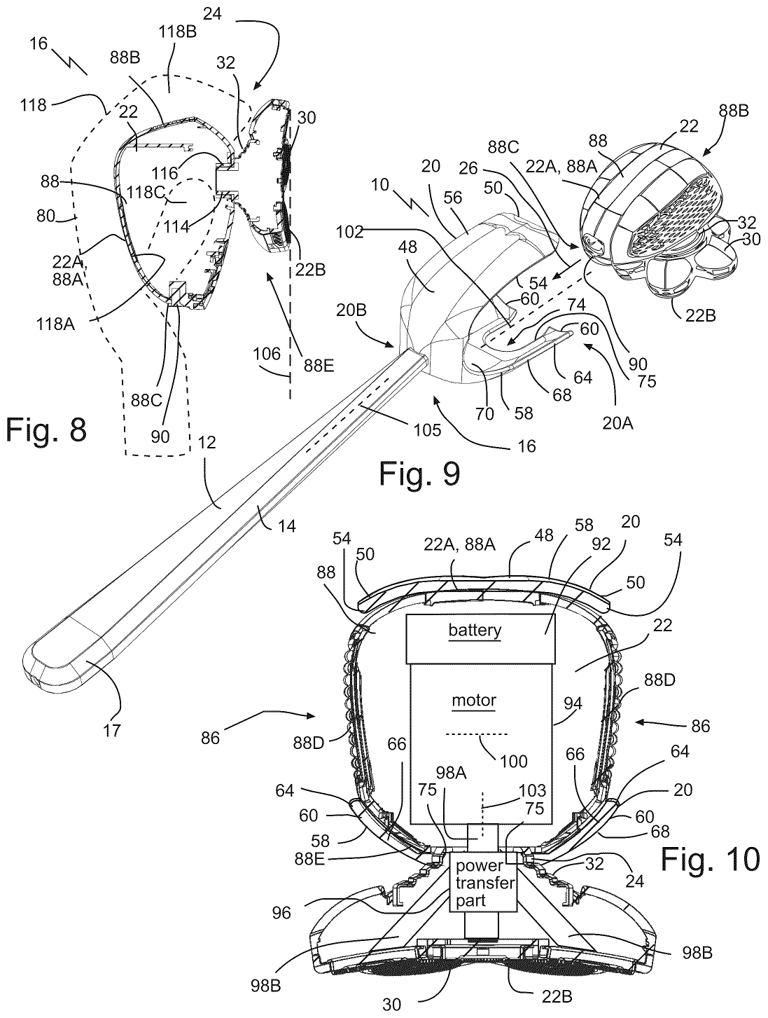

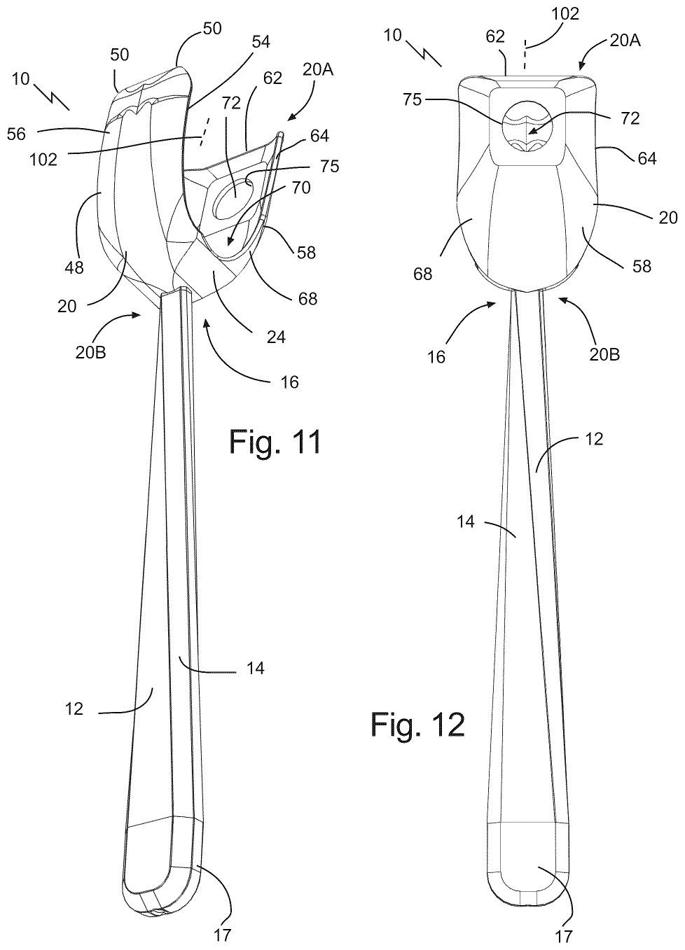

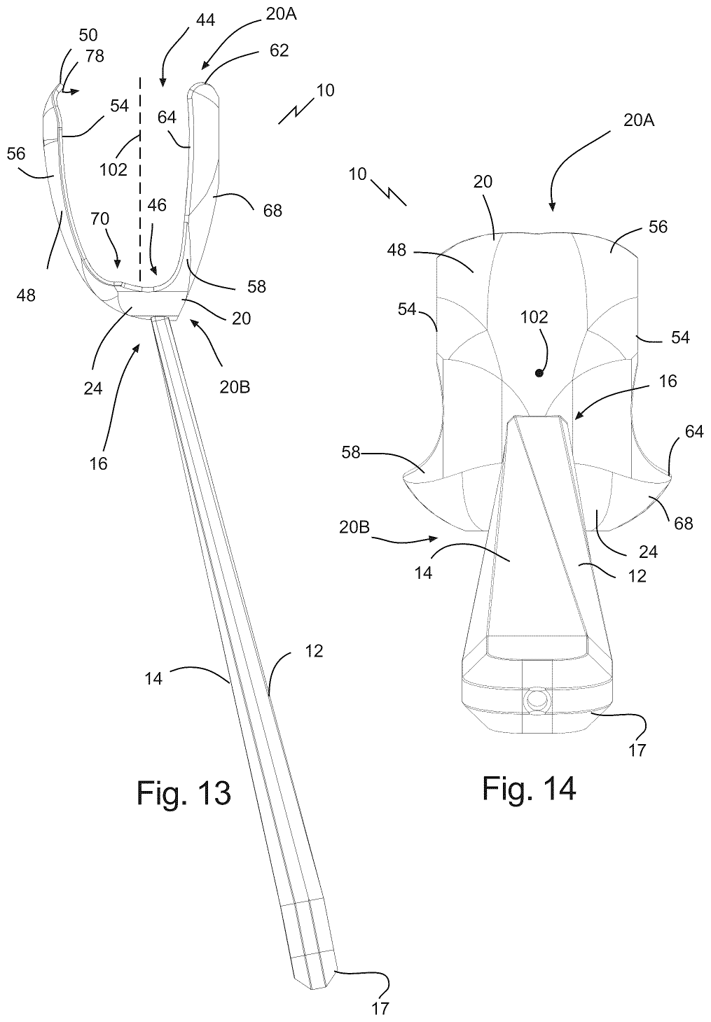

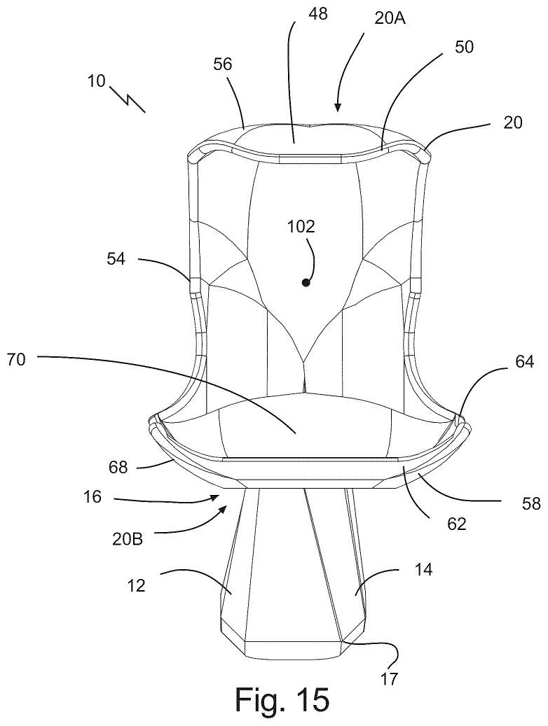

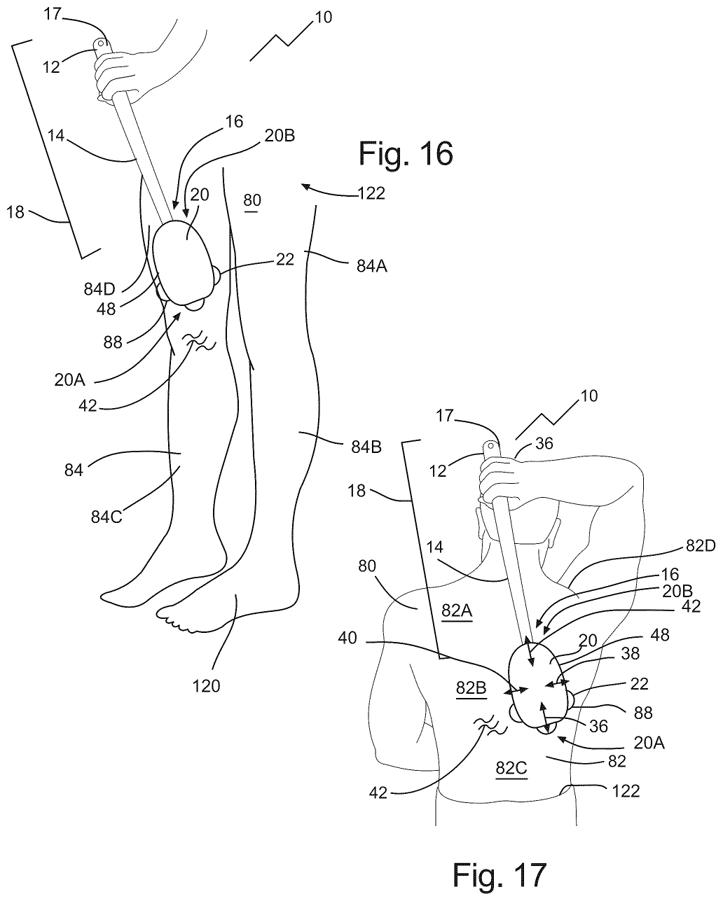

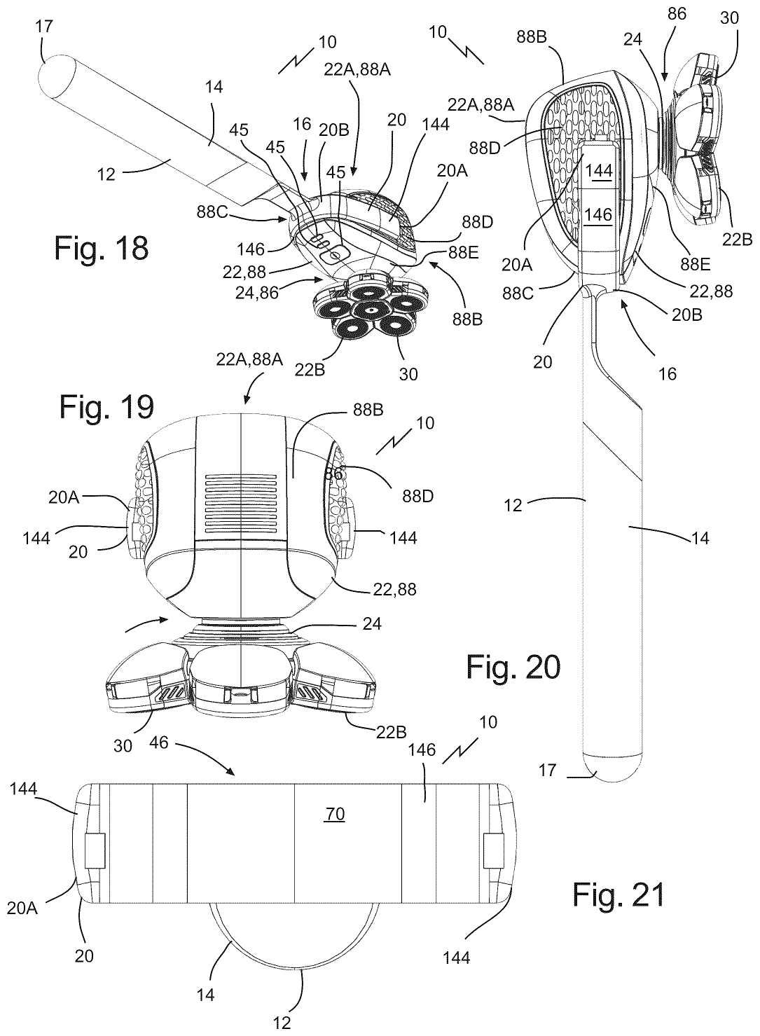

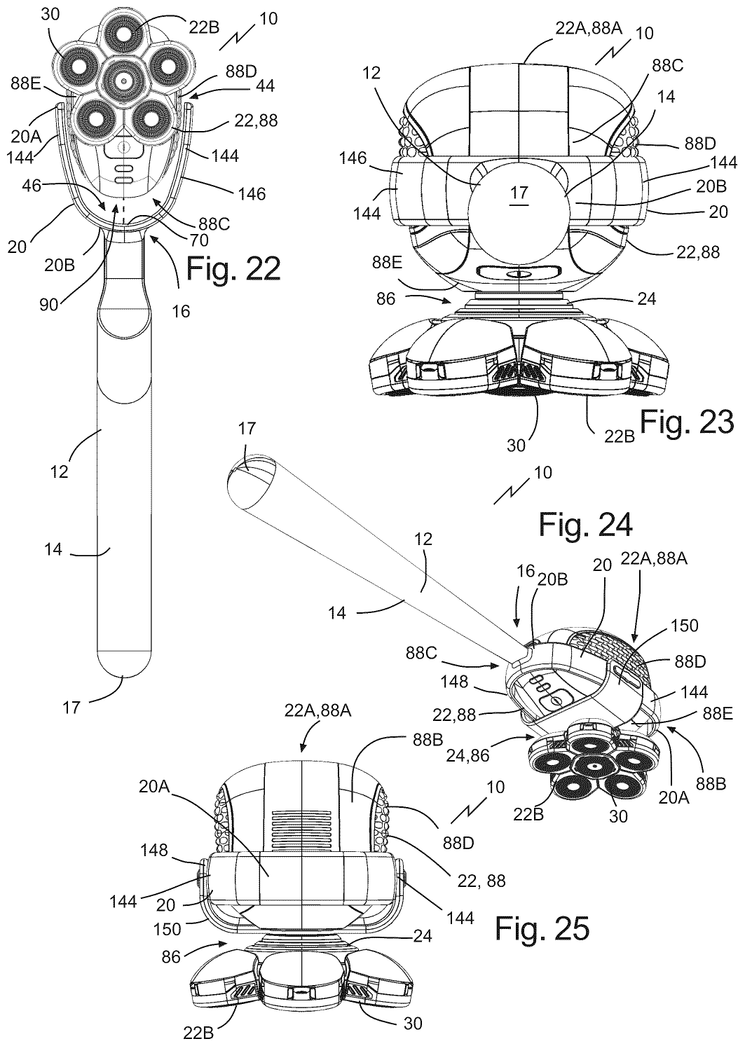

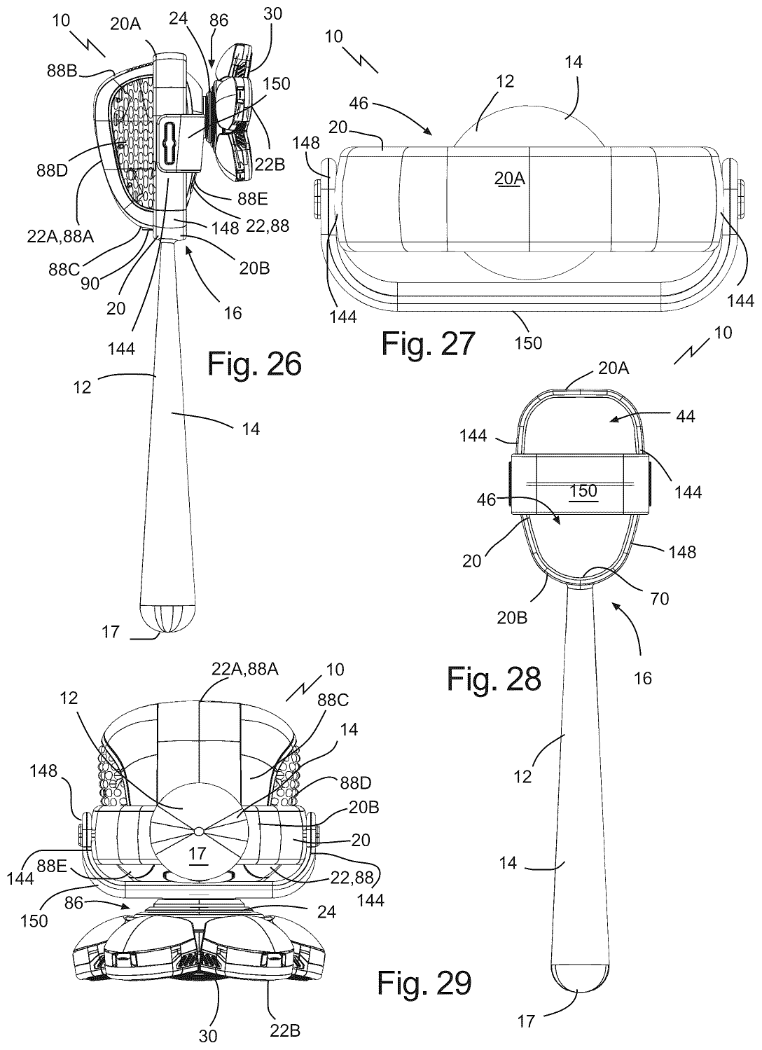

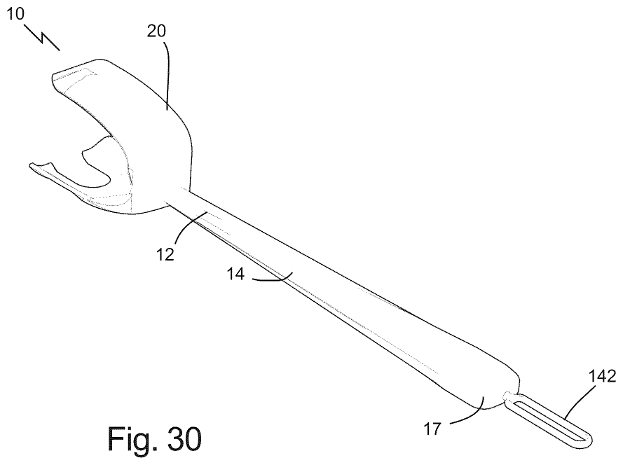

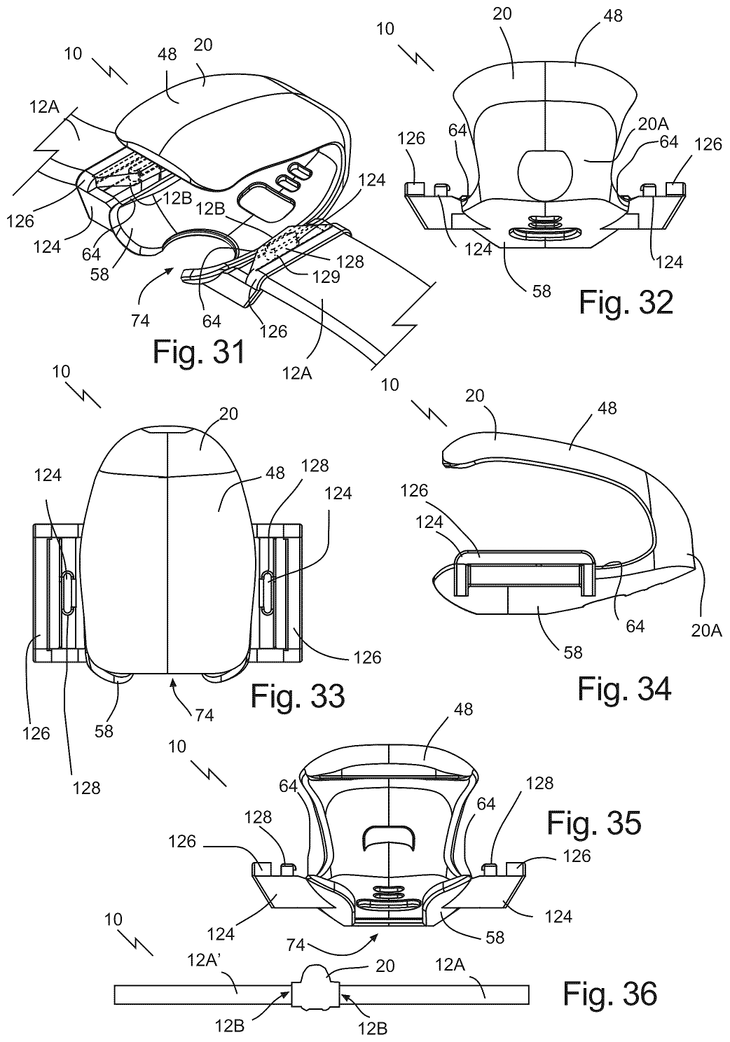

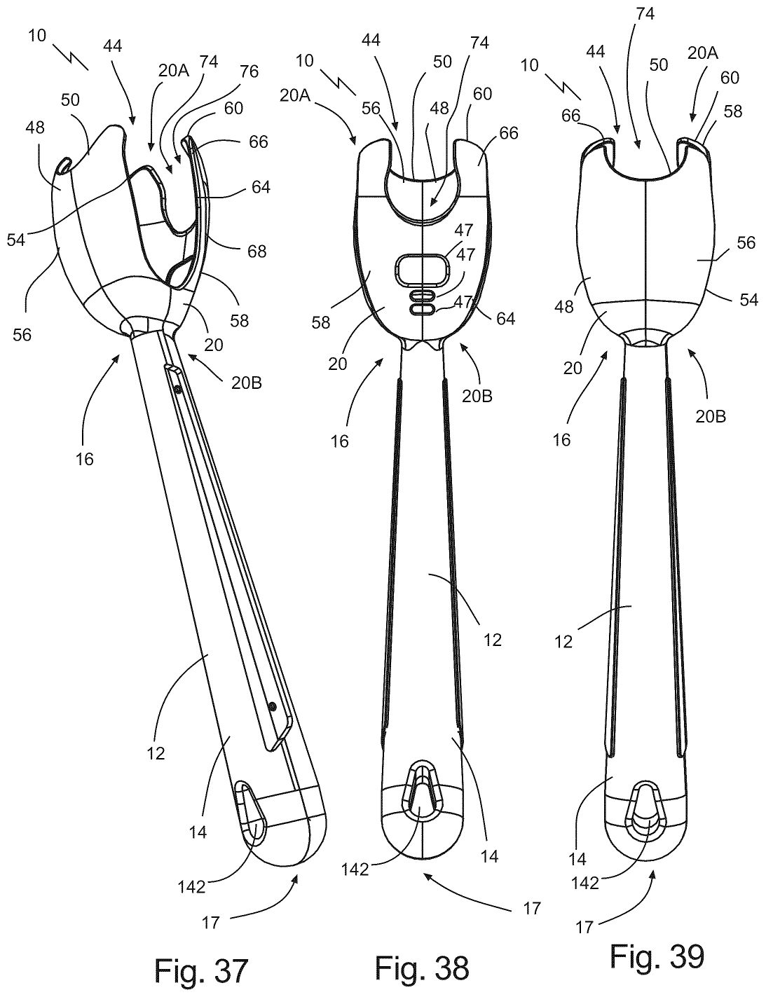

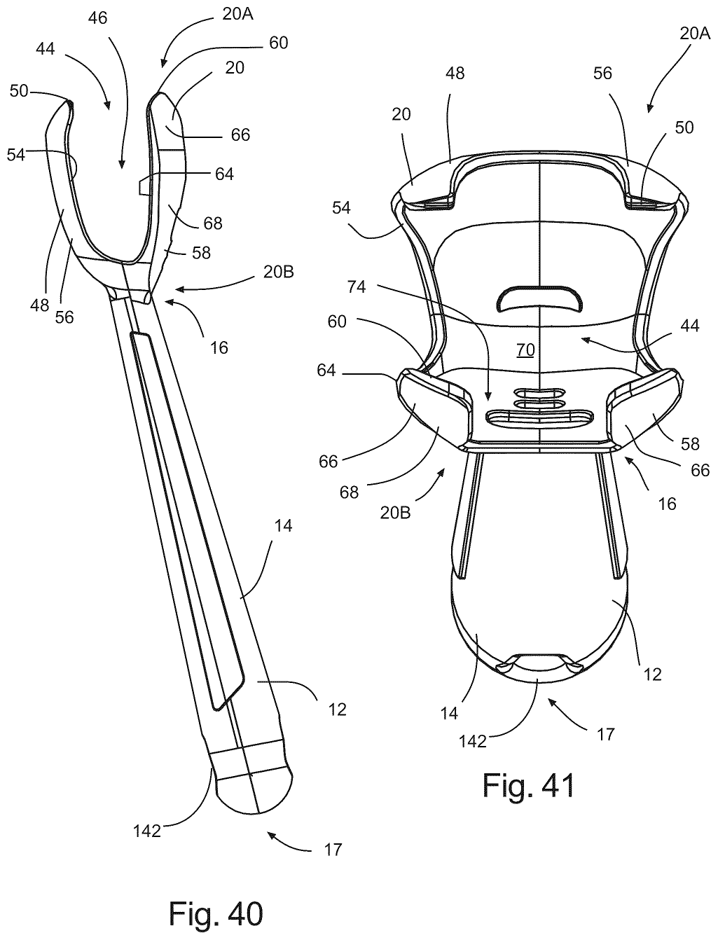

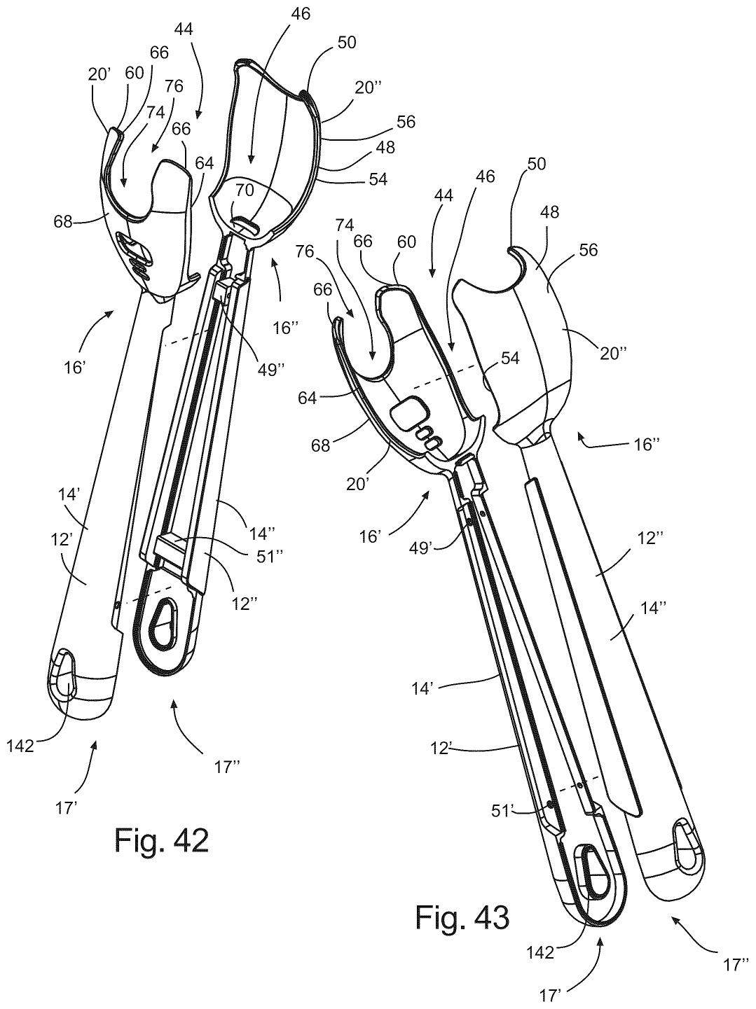

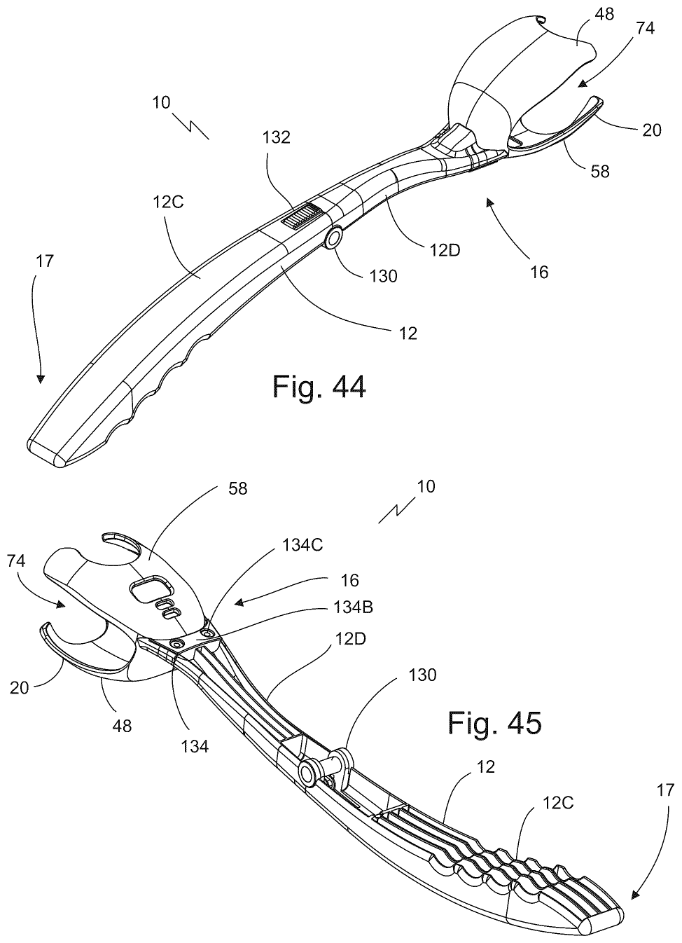

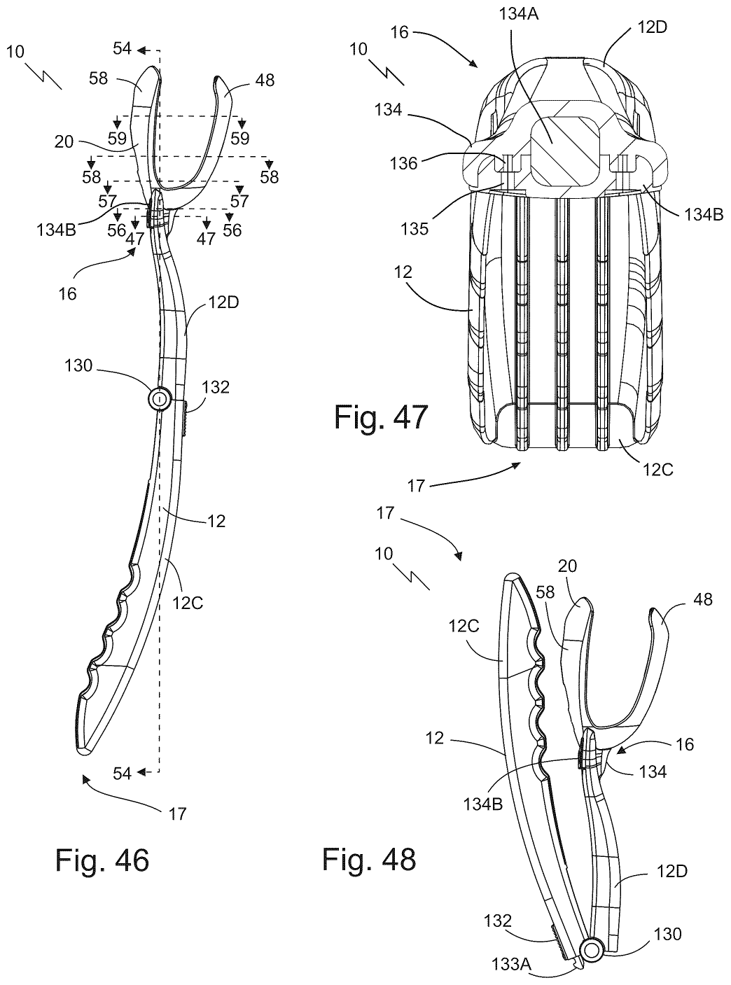

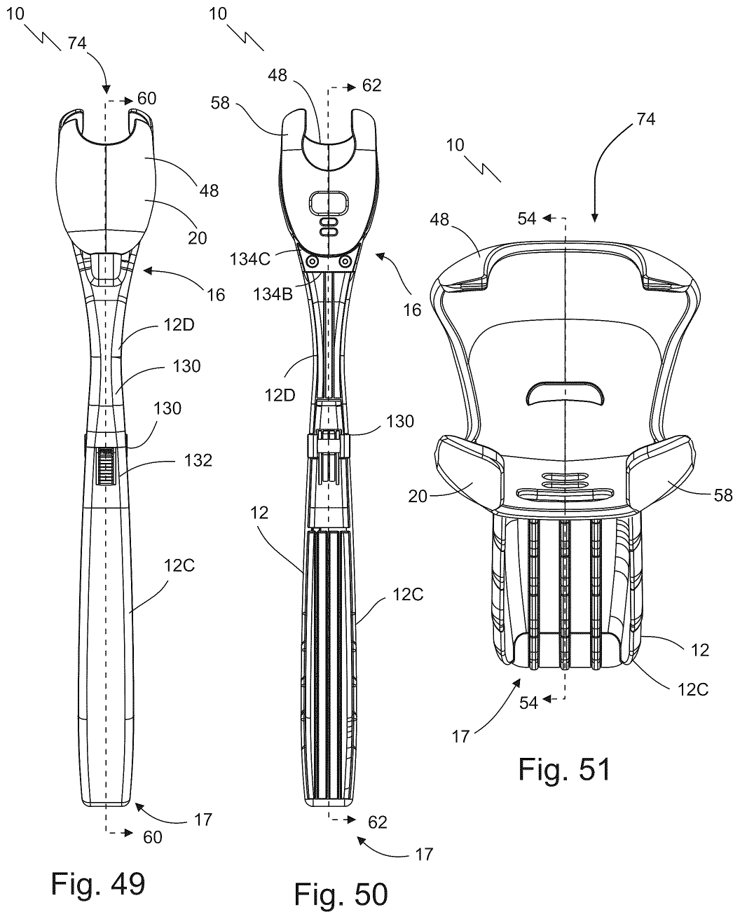

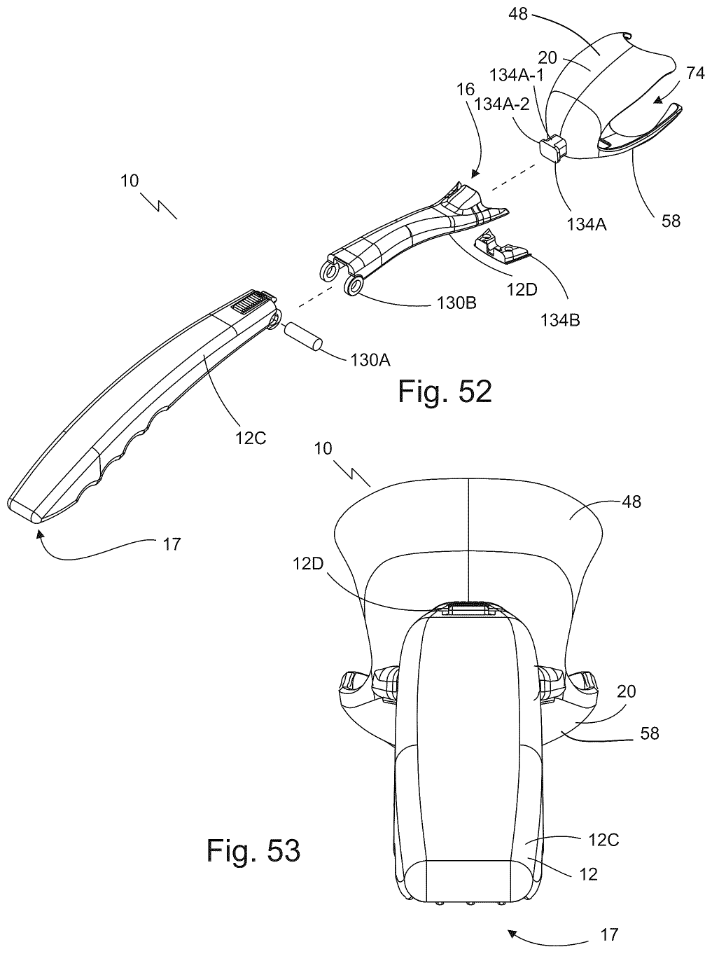

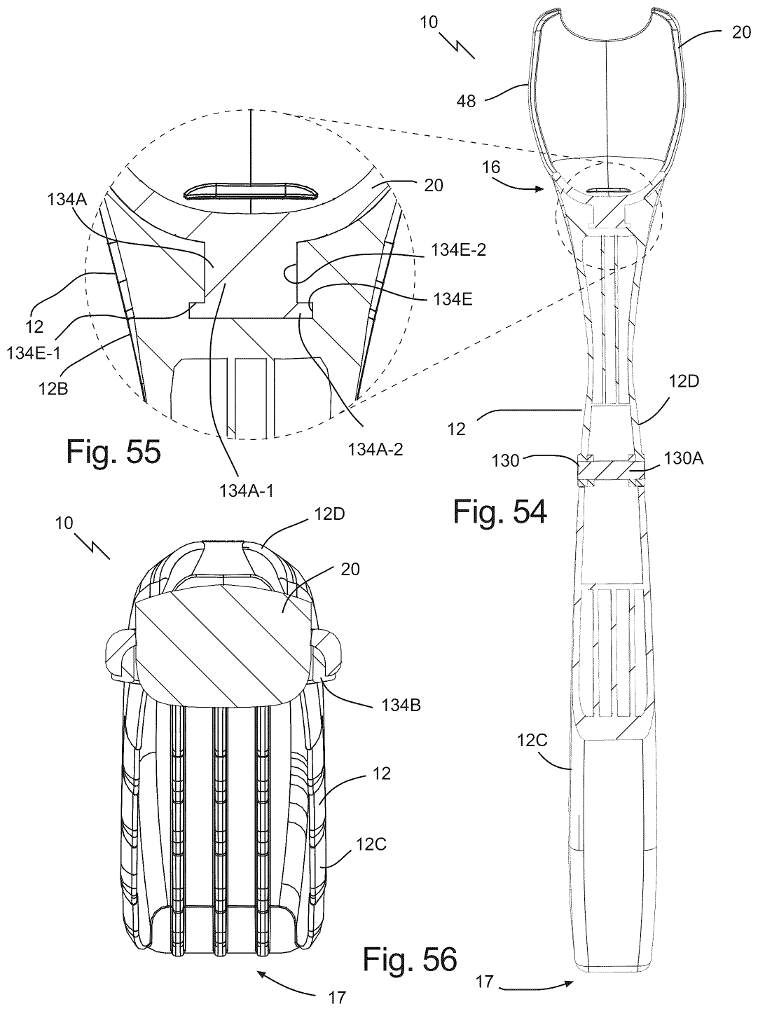

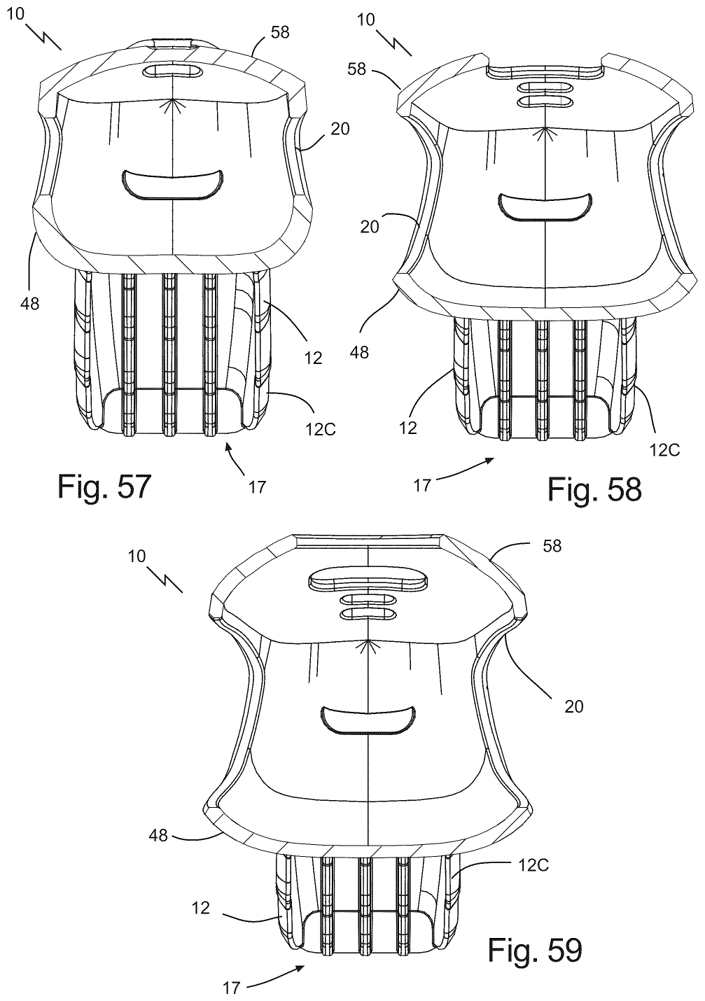

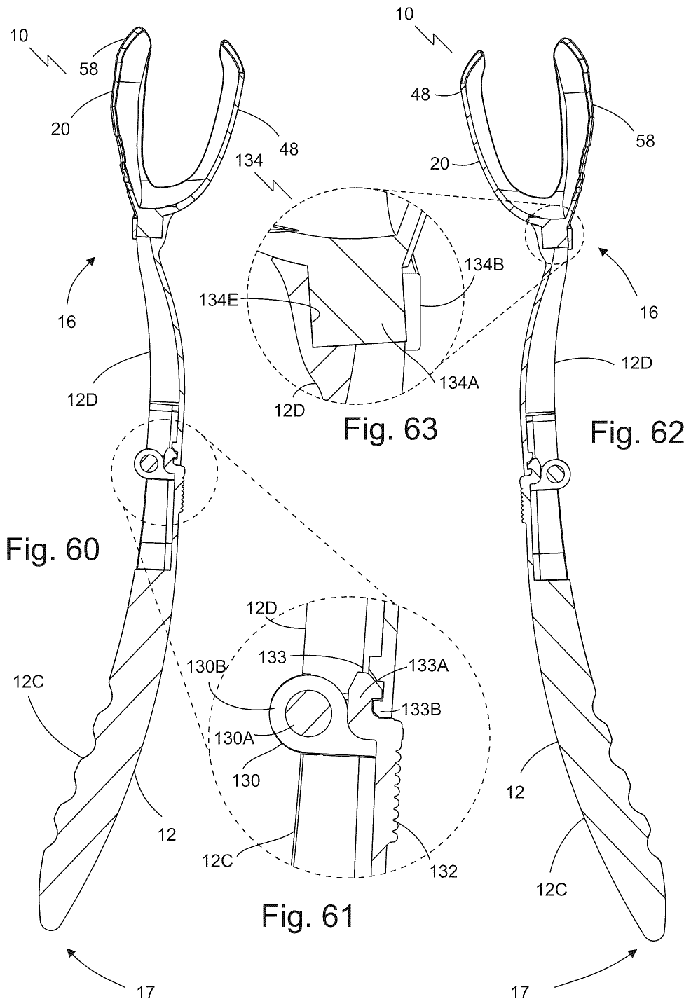

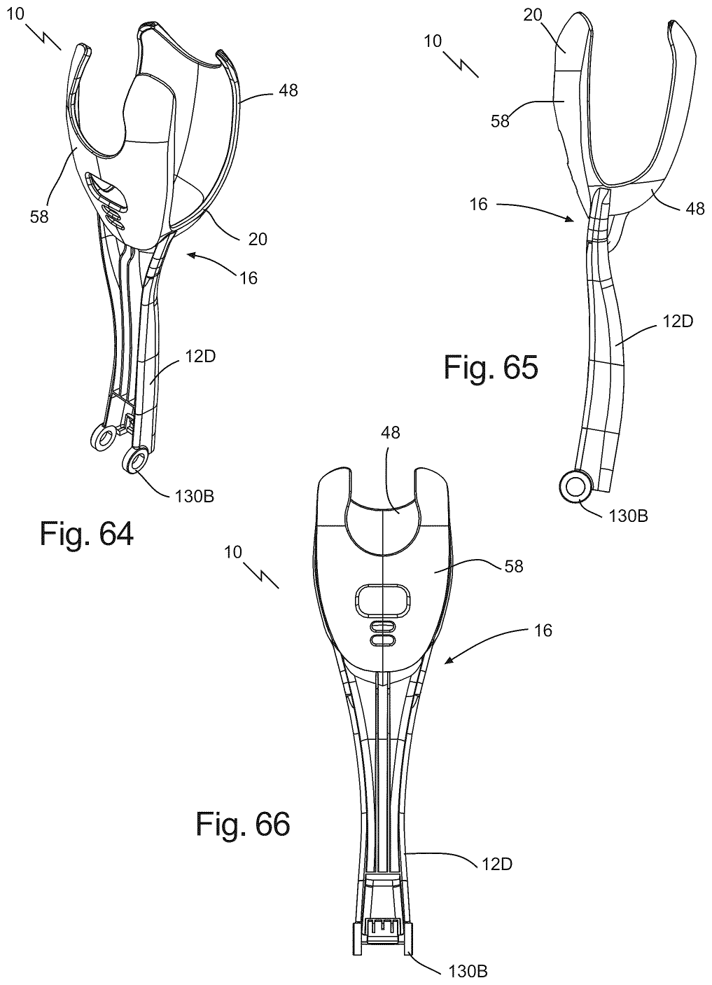

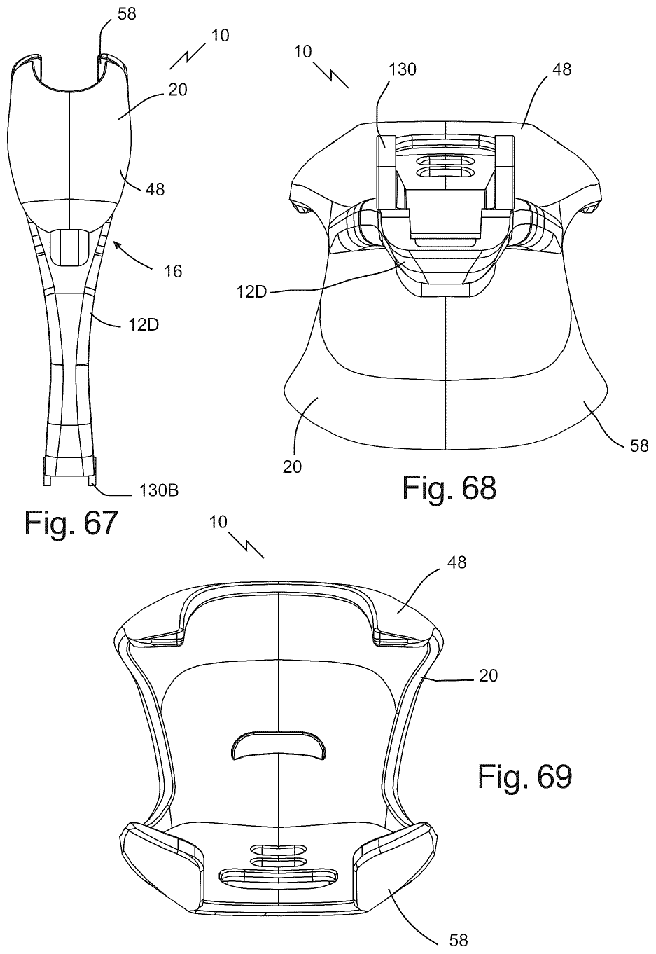

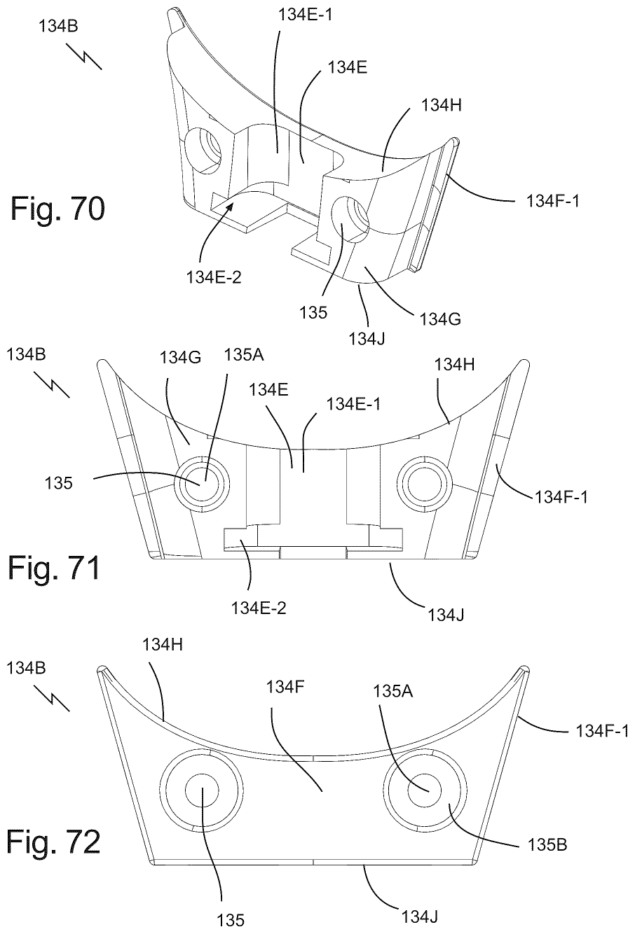

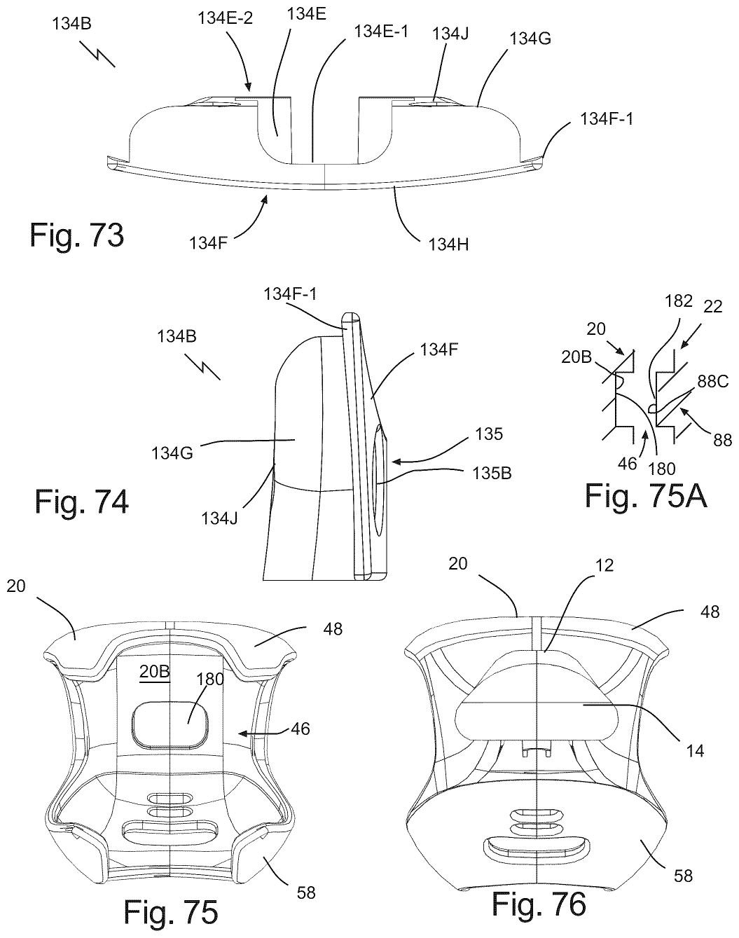

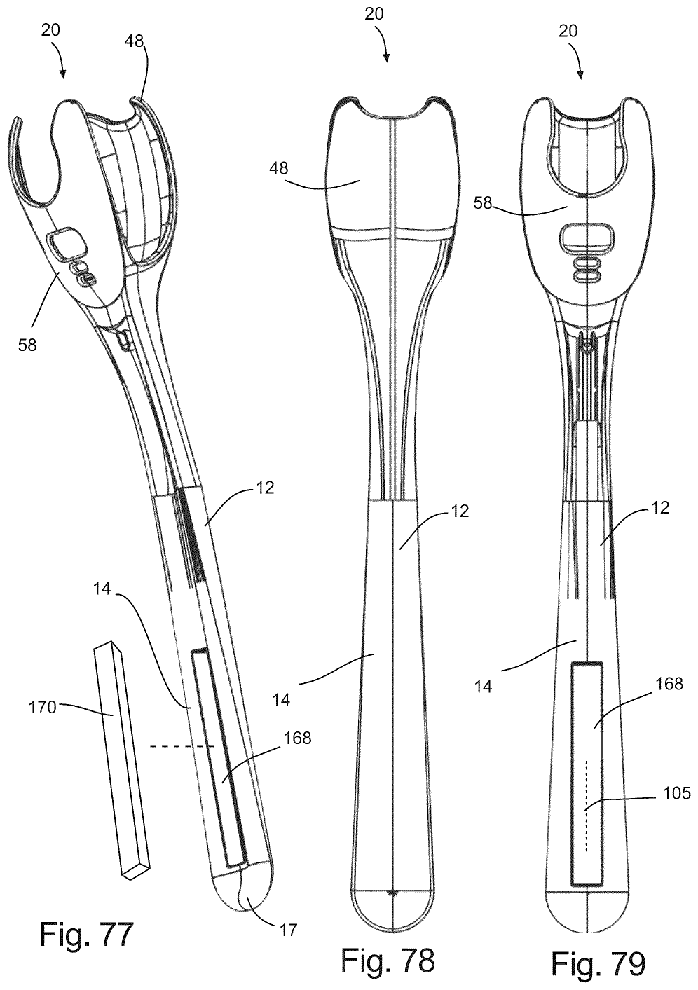

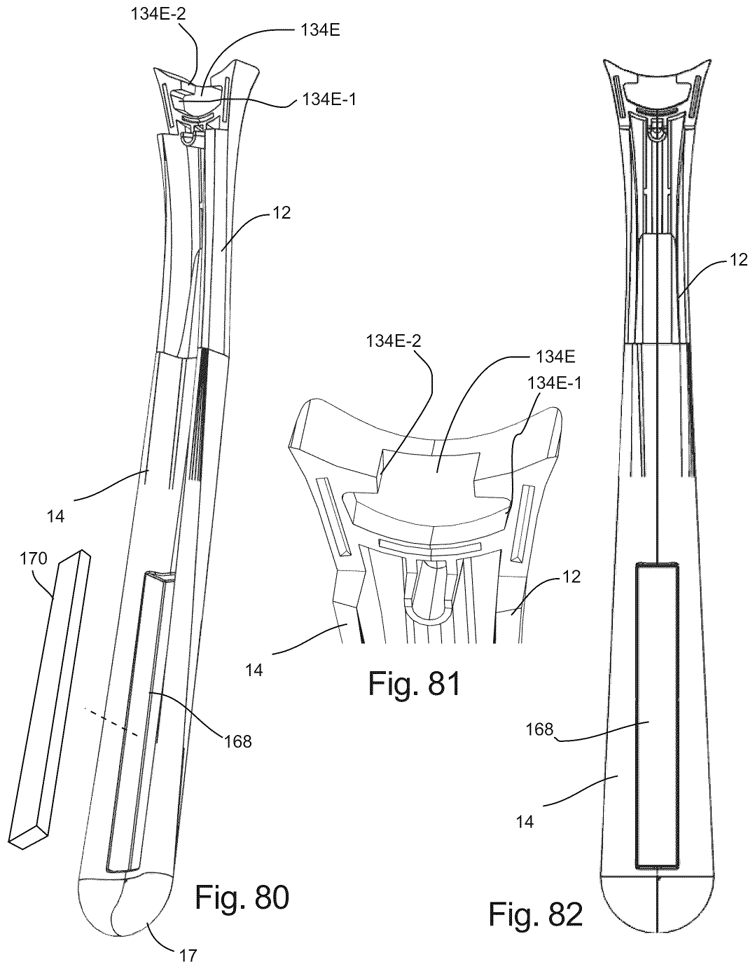

Referring to FIGS. 1-7, 9-10, and 16-17, a hair cutting device 10 may be provided to use with a hair cutting part 22 to cut hair on a user 80, for example on a body of the user. The hair cutting device 10 may comprise a handle part 12 with an elongate member such as a shaft 14. The handle part 12 may have a reversible connector 20, for example located at a head end 16 of the elongate shaft 14. The handle part 12 may be sized to permit a user 80 to remotely manipulate the hair cutting part 22 into contact with all areas of a back 82 and legs 84 of the user 80, for example for an adult human female or male of average characteristics, such as having one or more of average size, average weight, and average body mass index. During operation the user 80 may grip a tail grip end 17 of the elongate shaft 14. The reversible connector 20 may have claws, such as a base pincer claw 58 and a top pincer claw 48. The base pincer claw 58 and a top pincer claw 48 may be collectively shaped and structured to in use grip (for example cover) both the base part surface 88E of the palm knob 88 and a palm grip top surface, such as palm grip top end surface 88A, of the hair cutting part 22 defined by the palm knob 88, respectively. The base pincer claw 58 and top pincer claw 48 may cooperate to at least partially enclose the palm knob 88 within a palm-knob-receiving cavity 46, for example defined between the base and top pincer claws 58 and 48. The base pincer claw 58 may define a neck opening, such as a neck slot 74 that receives the neck 24 in use.

Referring to FIGS. 16-17, the handle part 12 may be structured to remotely manipulate the hair cutting part 22 into contact with all areas of the user's legs 84 (FIG. 16), back 82 (FIG. 17), or anywhere else on the body. A hair cutting device 10 is illustrated in use as comprising a combination of hair cutting part 22 and elongate handle part 12 connected together by reversible connector 20. Referring to FIG. 16, handle part 12 may have a size, length, and shape that permits self-administered use of hair cutting part 22 on otherwise hard-to-reach areas of the skin, for example legs 84, for example calves hamstrings 84A, calves 84B, shins 84C, and quads 84D. Moreover, handle part 12 may permit hair cutting part 22 to reach feet 120. Handle part 12 may permit remote cutting of hair 42 on legs 84 while a user maintains tail end 17 at or above a waist 122 of the user 80. In some cases, handle part 12 may permit a user who is overweight or late-term pregnant as the only means to self-administered shaving of legs 84 and/or back 82. Elongate handle part 12 may be curved, for example for ergonomic effect or to improve access to the legs 84 or back 82. Elongate handle part 12 may be rigid. Referring to FIGS. 17, elongate handle part 12 may be sized to permit a user 80 to remotely manipulate hair cutting part 22 into contact with all areas of the user's back 82, for example upper back 82A, mid-back 82B, lower back 82C, or shoulders 82D. The upper back 82A may refer to a portion of the back that overlies, or is laterally adjacent to a part of the back that overlies, the C1 to T4 vertebrae in a user's spine. The mid-back 82B may refer to a portion of the back that overlies, or is laterally adjacent to a part of the back that overlies, the T5 to T12 vertebrae of the user's spine. The mid-back 82B may comprise a central area of roughly ⅓ the surface area of the back 82 the user 80. The lower back 82C may refer to the lumbar section of the user's spine, for example overlying, or laterally adjacent to a part of the back that overlies, the L1 to L5 vertebrae. In one case a handle part 12 is shaped and size such that a user holds tail hand-grip end 17 of the handle part 12 in front of the user's chest, and the handle part 12 extends up, over the shoulders 82D, and down along the back to the hair cutting part 22.

Referring to FIGS. 16-17, elongate handle part 12 may be provided in a suitable length, such as an axial length 18. Elongate handle part 12 may have a length 18 between 10 inches and 30 inches. Elongate handle part 12 may be of sufficient length, for example 12 inches, to permit contact of hair cutting part 22 with the full surface of a user's legs 84 or back 82. Elongate handle part 12 may be sized relative to a back surface of an average-sized man, for example having a height of 70 inches and an arm length of 25 inches. Elongate handle part 12 may also be sized relative to a back surface of an average-sized woman, for example having a height of 64 inches and an arm length of 23 inches. Sizes and shapes of handle part 12 may also be provided for use on children of various ages and sizes. All references to a user in this document may be understood to refer to an adult male or female of average size unless context dictates otherwise.

The handle part 12 may have suitable characteristics to adjust the length of the handle part. A series of interchangeable handle parts 12 may be provided each with a unique shape and size tailored for a unique target area and/or size of user. The length 18 of the handle part 12 may be adjustable, for example if a telescopic handle part is used, or if the handle has pivotal or removable parts that can be adjusted or connected/disconnected, respectively, to increase or decrease length. The handle part 12 may comprise plural tubular parts made of varying relative sizes and mounted to slide between a nested position and an extended position. Other mechanisms may be used to adjust the length of the handle part 12, for example by providing the handle part 12 in plural pieces that pivot relative to one another between a stowed and a deployed position.

Referring to FIGS. 1-7, and 9-10, the reversible connector 20 may have a suitable shape in order to receive and reversibly secure the palm knob 88. The front end 20A of the reversible connector 20 may define terminal front tips 50 and 60, for example of the top and base claws 48, 58, respectively. The respective terminal front tips 60 and 50 of the base and top pincer claws 58, 48 may be spaced to define a palm-knob-receiving mouth 44. The palm-knob-receiving mouth 44 may define a lateral entry axis 102 for the hair cutting part 22 to enter and exit palm-knob-receiving cavity 46. Referring to FIGS. 1, 5, and 7, one or both of the respective terminal front tip or tips 60 of the base pincer claw 58 and the respective terminal front tip or tips 50 of the top pincer claw 48, may curl inward toward one another to retain a front part, such as a front-end surface 88B of the knob palm knob 88 between the respective front tips 60 and 50 and a rear end 70 of the palm-knob-receiving cavity 46. The handle part 12 may be connected to the rear end 20B of the reversible connector 20. The base and top claws 58 and 48 may connect to the rear end 20B of the reversible connector 20. The connection of the base and top claws 58, 48 may form an apex that defines rear end 70 in the palm-knob-receiving cavity 46. Curl in this document refers to a direction change in the structure of the claws where a portion of the palm knob 88 is blocked from removal from the palm-knob-receiving cavity 46. Curl does not require a curvature, and sharp directional changes may be used. Referring to FIGS. 5 and 7, the respective terminal front tip or tips 60 of the base pincer claw 58 and the respective terminal front tip or tips 50 of the top pincer claw 48 may collectively form a C-shape in cross-section, for example if one follows the shape of the claws 48 and 58 from tip 50 to rear end 70 to tip 60.

Referring to FIGS. 1-7 and 9-10, the reversible connector 20 may be structured to one or more of snap fit to and quick release from the palm knob 88. A snap fit, as an integral attachment feature, may be used as an alternative to using fasteners, such as nails or screws, or relatively more complicated locking systems, for example using levers and pins, and may have one or more of the advantages of speed and simplicity. A snap fit may be an assembly method used to attach resilient parts, such as made of plastic, to form the operative combination by pushing the parts' interlocking components together. The design of a snap-fit determines what it can be used for. There are several main types of snap-fits, including annular, cantilever, and torsional. A snap-fit joint may have a design of a protruding edge and a snap-in area. The specific name of the snap-fit is usually named after the type of stress or strain it utilizes, with the torsional snap-fit using torque to hold parts in place. To form a snap fit, including forming one or more of the reversible connector 20 and handle part 12 as a whole, a suitable assembly method may be used, such as molding. A mold of the parts may be created and hot liquid plastic poured into the mold. The mold contains the void (inverse) shape of the parts and the snapping component built in. Building a snap-fit design requires more precise engineering than a fastener assembly, and may be relatively more expensive. The hair cutting part 22 may be connected to the reversible connector 20 by inserting the palm knob 88 through palm-knob-receiving mouth 44 defined by the base and top pincer claws 58, 48 into the palm-knob-receiving cavity 46.

Referring to FIG. 7, the reversible connector 20 may be structured to resiliently move between an open position and a closed position. In the example shown the terminal front tips 50, 60 of the top and base pincer claws 48, 58, respectively are both shown in the closed position (solid lines) and open position (dashed lines). The reversible connector 20 may be biased into the closed position (tips 50, 60 in solid lines), with the base and top pincer claws 58, 48 covering (overlying) and gripping the palm knob 88 in the closed position. In the open position the base and top pincer claws 48 and 58 may be spread relatively apart from each other (tips 50, 60 in dashed lines) to permit release of the palm knob from the palm-knob-receiving cavity. Although the dashed and solid lines show only the front tips 50, 60 moving, in the embodiment shown and in other cases the entirety or a substantial part of the claws 48, 58, may move relative to the apex or rear end 70 of the connector 20.

Referring to FIG. 7, the base pincer claw 58 and the top pincer claw 48 may form resilient cantilever snap fits, which may permit the reversible entry and retention of the hair cutting part 22 within the reversible connector 20. A cantilever snap-fit may be reversible as shown, or permanent. A reversible snap-fit may have a lever or pin (not shown) to be pushed, in order to undo the snap-fit. In use the hair cutting part 22 may latch the base and top pincer claws 58, 48 onto the palm knob 88 by snap fit. The top pincer claw 48 may form a snap fit cantilever with the top end surface 88A and front-end surface 88B of the palm knob 88, with the front tip 50 forming a catch that hooks the front-end surface 88B once the palm knob 88 is sufficiently advanced within the cavity 46 along axis 102. The bottom pincer claw 58 may form a snap fit cantilever with the bottom surface 88E and front-end surface 88B of the palm knob 88, with the front tip 60 forming a catch that hooks the front-end surface 88B once the palm knob 88 is sufficiently advanced within the cavity 46 along axis 102.

Referring to FIGS. 7 and 9, the reversible connector 20 may be structured to friction fit to the palm knob 88. An interference fit, also known as a press fit or friction fit is a form of fastening between two tight fitting mating parts that produces a joint which is held together by friction after the parts are pushed together. A rear part, such as including rear end 20B of the palm-knob-receiving cavity may be shaped to conform to a rear part, such as rear end surface 88C of the palm knob 88 to form the friction fit therebetween. The rear part of the palm knob 88 may be tapered to have decreasing lateral dimensions, such as one or more of width and height, with decreasing distance to rear end surface 88C of the palm knob 88. The rear part of the palm-knob-receiving cavity 46 that conforms to the rear part of the palm knob 88 may be tapered to have increasing lateral dimensions, such as one or more of width and height, with increasing distance from the rear end 20B of the palm-knob-receiving cavity 46. Advantages of a taper fit/taper form may include one or more of the following: a) the possibility of abrasion of the fitted surfaces is reduced, b) less pressure is required in assembling, and c) parts may be more readily separated when renewal is required. In the example shown, the rear part or portion of the palm knob 88 has a bulbous-conical shape, which the inside surfaces of the rear part or portion of the palm-knob-receiving cavity 46 conforms to. Conformal shaping is understood to include sizing adjustments to provide a friction fit, for example to provide an interference or press fit (an example of a friction fit) the cavity 46 may be dimensioned slightly smaller than the exterior dimensions of the palm knob, with resiliency in the connector 20, to permit a friction fit to form therebetween on engaging the two together. The rear part of the cavity 46 may be structured to increase gripping, for example if textured with a low slip gripping surface or pad, such as a rubber or deformable pad. In general, the interior surfaces of part or all of the connector 20 may be structured to increase gripping in a similar fashion.

Referring to FIG. 7, the palm knob 88 may be inserted into the cavity 46 via a suitable mechanism. The hair cutting part 22 may be connected to the reversible connector 20 by opening the base and top pincer claws 58 and 48 and inserting the palm knob 88 through the palm-knob-receiving mouth 44 into the palm-knob-receiving cavity 46 along axis 102. One or both of top end surface 88A and base surface 88E of the palm knob 88 may be tapered with decreasing separation between top surface 88A and bottom surface 88E in one or both of a direction moving toward rear end surface 88C and a direction moving toward front-end surface 88B. As the palm knob 88 advances toward mouth 44 along axis 102 and front-end surface 88B contacts exterior surfaces of tips 50 and/or 60, the tapered end surface 88B forms a ramp or ramps that push tips 50 and 60 apart to move the claws 48, 58 into the open position. Once in the open position, the palm knob 88 may be advanced further along axis 102, until tips 50 and 60 begin to close to catch the front-end surface 88B of the palm knob 88, securing the palm knob 88 in the cavity 46. In some cases, a lever or other actuator is provided to allow a user to manually open and/or close the mouth 44.

Referring to FIG. 7, the palm knob 88 may be removed from cavity 46 via a suitable mechanism. The hair cutting part 22 may be disconnected from the reversible connector 20 by opening the base and top pincer claws 58 and 48 and retracting the palm knob 88 through the palm-knob-receiving mouth 44 from the palm-knob-receiving cavity 46 along axis 102. In some cases, the removal of the palm knob 88 is the reverse of the insertion procedure. As the palm knob 88 moves along axis 102 to advance away from rear end 70 of the connector 20, the front-end surface 88B of palm knob contacts interior surfaces of tips 50 and/or 60, with the tapered end surface 88B forming a wedge ramp or ramps that push tips 50 and 60 apart to move the claws 48, 58 once more into the open position. Once in the open position, the palm knob 88 may be advanced further along axis 102 away from rear end 70 of connector 20, until tips 50 and 60 begin to close after or adjacent rear end surface 88C, releasing the palm knob 88. The shape of interior surfaces of the tips 50, 60 may conform to a shape of exterior surfaces of the palm knob 88, for example if all are curved as shown. The tapering of the front and rear portions of the palm knob 88 are shown with a steeper taper on the front part and a shallow taper on the rear part. In such a case, a user obtains a relatively larger force advantage from the wedging effect of the rear part of the palm knob 88 when inserting the palm knob 88 than when removing the palm knob 88. Thus, the user must overcome a relatively higher force threshold to remove the palm knob 88 than insert it in the cavity 46, meaning that the palm knob 88 is relatively easily connected to the connector 20 and will not become dislodged or accidentally removed from connector 20 when in use and under forces similar to those that inserted the palm knob 88 into the connector 20 in the first place.

Referring to FIG. 7, the connector 20 may be structured to permit the hair cutting part 22 to be removed from the reversible connector 20 in a fashion that allows the connector 20 to be reused. A reversible connection may permit the palm knob 88 to be connected to the reversible connector 20 to a degree sufficient to retain palm knob 88 in use at the desired position in the reversible connector 20 during operation of the hair cutting part 22, until the user 80 desires to remove the palm knob 88 after operation of the hair cutting part 22 is completed. The palm knob 88 may be connected by a relatively low degree of permanence, and can be removed, without causing damage to any of the parts of the device 10, and in a fashion that permits the palm knob 88 to be re-used for example re-secured in the reversible connector 20 or another reversible connector 20 as the case may be. A snap fit may be selected to not be exhausted during the detachment process, meaning that it may be able to be reused. The reusability of the snap fit may allow for the re-use of the palm knob 88 in order to carry out the method of attachment again for example 50, 100, 500, 1000 or more times over.

Referring to FIGS. 1-7 and 9-11, one or both of the top pincer claw 48 and base pincer claw 58 may be structured to retain the palm knob 88 within the cavity 46 against side removal. Side removal may refer to removal along a side axis 100, for example transverse axis 102 and/or a neck axis 103 (FIG. 10) of hair cutting part 22. Referring to FIGS. 4, 5, and 10, one or both of claws 48, 58 may have opposed side edges 54, 64 that curl inward toward one another to retain opposed sides/surfaces 88D of the palm knob 88 within the palm-knob-receiving cavity 46. Side removal may refer to removal through side finger access slots 86 defined between edges 54, 64 of claws 48, 58. Finger access slots 86 may be used by the user 80 to interact with the palm knob 88, for example to one or more of adjust the palm knob 88 within the reversible connector 20, remove the palm knob form the reversible connector 20, interact with controls on the palm knob 88 for operating the hair cutting part 22 (for example to access a power button (not shown)), or for various other reasons. Access to the opposed side surface 88D of the palm knob 88 may also assist the user 80 in removing the palm knob 88 from the reversible connector 20, as the user 80 may use his or her fingers to engage the opposed side surfaces 88D of the palm knob 88 with one hand, and hold the handle part 12 or connector 20 with the other hand, applying a separating force between the two hands to cause the separation of palm knob 88 from connector 20.

Referring to FIGS. 4, 5, and 10, the side edges 54 and 64 allow the reversible connector 20 to retain the opposed side surfaces 88D of the palm knob 88. The opposed side edges 64 and 54 may be rigid and do not flex sufficient to insert or remove the palm knob through slots 86. In other cases, the opposed side edges 64 and 54 of one or both the base pincer claw 58 and the top pincer claw 48 may form resilient cantilever snap fits. Suitable materials may be used to provide resiliency, such as by using acrylonitrile butadiene styrene (ABS) plastic, with or without the addition of filler such as glass to adjust resiliency. The side edges 54 and 64 may contact the opposed sides surfaces 88D of the palm knob at four points, allowing the palm knob to be secured in the reversible connector and reducing or eliminating the side-to-side movement of the palm knob 88, and forming a channel into and out of the mouth 44 via axis 102. The shape of interior surfaces of the edges 64 and 54 may conform to a shape of exterior surfaces of the palm knob 88, for example if both are curved as shown. The side edges 54, 64 may retain curl from tips 50, 60 to rear end 70, where the edges 64 and 54 meet, for example to add rigidity and retention against side removal of palm knob 88.

Referring to FIGS. 1-7, 9-11 and 13, one or both of the base and top pincer claws 58, 48 may be provided with an internal shape similar to a cup to retain the palm knob 88. For example, one or both of the base pincer claw 58 and the top pincer claw 48 may define canopy or cupping members, 68 and 56, respectively. The base pincer claw 58 and the top pincer claw 48 may define a base cupping member 68 and a top cupping member 56, respectively, that collectively define the palm-knob-receiving cavity 46. The base cupping member 68 may at least partially define the palm-knob-receiving cavity 46, when the base and top pincer claws are in the closed position. The top cupping member 56 and the base cupping member 68 may at least partially define the palm-knob-receiving cavity 46 when the base and top pincer claws are in the closed position. The cupping members 56 and 68 may be shaped to cup the palm knob 88, for example surfaces 88A and 88E, when in the closed position to form the palm-knob-receiving cavity 46, similar to a clamshell.

Referring to FIGS. 1-7 and 9-10, the reversible connector 20 may be structured to receive the neck 24 of the hair cutting part 22. The base pincer claw 58 may comprise a pair of opposed side fingers 66. Referring to FIGS. 1, 3, 4, and 10, the opposed side fingers 66 may be separated laterally to define the neck opening as a neck slot 74. The slot 74 may be structured to be open to receive the neck 24, for example the tips 60 of the opposed site fingers 66 may be separated to define a neck receiving mouth 76 to the neck slot 74. The neck slot 74 may be structured to receive the neck 24 of the palm knob 88, for example as the palm knob 88 with blade 30 connected thereto, are advanced along axis 102 into the mouth 44 of reversible connector 20. The neck slot 74 may allow the palm knob 88 to be fully inserted within the palm-receiving cavity 46, properly aligned with the neck 24 in the slot 74. Interior edges 75 of the neck slot 74 may contact the neck 24 in use, for example to stabilize the palm knob 88 in a desired orientation in the cavity 46. The base pincer claw 58 may grip the neck 24 about the neck slot 74, for example to steady and stabilize the palm knob 88 in a desired orientation within the cavity 46 during use.

Referring to FIGS. 11-15, a second embodiment of a reversible connector 20 is illustrated in the context of a hair cutting device 10. The connector 20 shown may form a closed path about the neck 24 in use. The base pincer claw 58 may define an oval, circular, arcuate, or other suitably shaped closed path neck opening 72. In such embodiment, the neck opening 72 may assist in retaining and securing the palm knob 88, and may prevent removal of the palm knob 88 when the knob 88 is installed in the cavity 46 with the blade 30 installed on the palm knob 88. Referring to FIG. 8, to install the palm knob 88 in such an embodiment, the user 80 would first disconnect the blade 30 from the palm knob 88 (or otherwise disconnecting and removing the blade 30 from the knob 88), for example by withdrawing the blade stem 114 from the blade stem receiver 116, separating the two parts. Referring to FIGS. 11-15, the palm knob 88 would be inserted along axis 102 into cavity 46, where the blade stem receiver 116 of palm knob 88 aligns with neck opening 72. Finally, the blade stem 114 is inserted through neck slot or opening 72 from the base side into the receiver 116 of knob 88 (or the blade 30 is connected to the knob 88 using suitable other connectors), securing the palm knob 88 and blade 30 together and within cavity 46. To remove the palm knob 88 from cavity 46, the reverse procedure may be followed, by disconnecting the blade stem 114 and receiver 116 (or otherwise disconnecting and removing the blade 30 from the knob 88), and withdrawing the palm knob 88 from the cavity 46. In other cases, an open path neck slot 74 may be used instead of a closed path opening, but with a neck lock (not shown) provided to allow the user to lock and unlock the mouth 76.

Referring to FIGS. 9 and 10, the multi-directional motorized blade 30 may be connected to pivot relative to one or more of the neck 24, the palm knob 88 or the handle part 12. Pivoting action may allow the multi-directional motorized blade 30 to efficiently glide over and conform to the differing contours of a user's 80 back 82 or legs 84. Being able to adjust position of the blade 30 over differing contours of skin surface may allow the blades 30 to provide a relatively even cut of the user's hair over varying skin topography. The ability to pivot may be coupled with a biasing device that permits the blade 30 to return to a neutral, un-pivoted position in the absence of forces that would otherwise cause the blade 30 to pivot. Thus, the device 10 may be structured to permit the hair cutting part 22 to pivot, relative to the elongate handle part 12, from a neutral position (dashed lines), for example into a flexed position (solid lines), upon application of a pressure above a predetermined threshold, and to return to the neutral position upon release of the pressure. Referring to FIG. 10, in the example shown the blade 30 is structured to pivot about axis 103, for example to one or both rotate about axis 103, and bend at non-zero angles relative to axis 103 (the latter of which would form an omni-directional pivot connection). Referring to FIG. 9, in some cases handle part 12, for example connector 20, may be structured to pivot relative to blade 30. For example, the shaft 14 may be structured to pivot, for example to one or both rotate about shaft axis 105, and bend at non-zero angles relative to axis 105 (the latter of which would form an omni-directional pivot connection). A pivot connection is one example of a structure that permits the hair cutting part 22 to move relative to the elongate handle part 12. In some cases, the elongate handle part 12 is adapted to pivot through a living hinge or resilient portion of the device. Pivoting may be achieved via a suitable mechanism. Deflection may be achieved via resilient character within the handle part 12 or hair cutting part 22 or both, or by other means, such as via a torsional spring. In the example shown the handle part 12 may have a portion that is made of resilient material, such as a polymeric material, that deflects under pressure, and returns to the neutral state upon release of the pressure. Deflection is understood to refer to elastic bending. The resiliency of the material may be tailored to achieve a predetermined threshold force that may be surpassed during operation using the strength of the user. In some cases, the ability to return to neutral may be achieved using a spring or other biasing system, for example if a pivot hinge with a torsion spring (not shown) is provided. Various types of relative motion may be achieved. In some cases, one or both of the elongate handle part 12 and the hair cutting part 22 are structured to permit the hair cutting part 22 to pitch up and down. For example, the part 22 may be permitted to pivot about an axis that is defined perpendicular to a handle part axis and parallel to a plane that is defined by a cutting end of the hair cutting part 22. As the user advances the hair cutting part 22 along a surface of the user's body, the hair cutting part 22 may deflect, relative to the elongate handle part 12, from a neutral position into a deflected position. The deflection may occur when the hair cutting part 22 encounters changing topography on back 82 during advancement.

The elongate handle part 12 may be structured to permit pivoting of the hair cutting part 22 about a plurality of axes, for example the elongate handle part 12 may be connected for omni-directional pivoting relative to the hair cutting part 22. Omnidirectionality in this document may refer to the ability of one part, such as part 12, to pivot in any angle about a plane relative to another part, such as the cutting part 22. One structure that permits such movement is a gimbal (not shown). The gimbal may comprise a multi-axis, for example dual or tri-axis, concentric ring gimbal set. A gimbal set may comprise an outer ring, an intermediate ring nested within the outer ring, and an inner ring nested within the outer ring. The rings may each form respective gimbals. Two or more gimbals may be present. Other types of omni-directional pivoting parts may be used. For example, a ball joint or universal joint may be used. An example of a ball joint is formed on the handle end of the EVENCUT™ device, for example using a cap that fits over the handle end to define an external surface whose shape follows that of a sphere, ellipsoid, ball, or other surface that provides omni-directional pivoting, for a handle connector part to engage and slide over, similar to a hip or shoulder joint.

One or both of the elongate handle part 12 and the hair cutting part 22 may be structured to permit the hair cutting part 22 to roll laterally, for example to the left or right. For example, the part 22 may be permitted to pivot about an axis that is defined parallel, for example coaxial, to a handle part axis. During advancement the hair cutting part 22 may traverse sections of the user's skin that slope up or down in a direction lateral to the direction of skin travel of the hair cutting part 22 across the skin. Such topography may force the hair cutting part 22 to roll to the side as shown. Pitch and roll pivoting are examples of pivoting about axes that are perpendicular and parallel, respectively, to the elongate handle part 12. In some cases, the parts 12 and 22 may be structured to pitch and roll at the same time, for example when encountering complex topography.

The device 10 may be operated in and transitioned conveniently between a handheld and a handle mode. For example, the user may begin shaving in one of the handheld and handle mode (handle disconnected from and connected to hair cutting part 22, respectively) and thereafter switch into the other mode, and then back again. The handheld mode may be advantageous for fine cutting, whereas the handle mode may be advantageous for rough cutting, and thus the two modes may be conveniently leveraged by a user on the fly to provide a suitable hair cutting experience.

Referring to FIGS. 18-28, two additional embodiments are shown that incorporate a friction fit connection between connector 20 and hair cutting part 22. In the examples shown, the connector 20 has opposed pincer claws 144, which reach around to grip side surfaces 88D of the palm knob 88. The claws 144 may be structured to grip surfaces 88D at a location on the surfaces 88D where the surfaces 88D are indented. The claws 144 may form part of a suitable shaped part, such as a cantilever or C-shaped gripper part 146 (FIGS. 18-23) or a circumferential or O-shaped gripper part 148 (FIGS. 24-29), of the connector 20. Referring to FIGS. 24-29, an additional part may be provided to receive the neck 24 of the palm knob 88, such as a U-shaped bracket 150 depending from the sides of the gripper part 148 to define the neck slot 74 (not shown) to receive the neck 24. Referring to FIGS. 18-29, the rear part of the gripper part may conform to the shape of the rear part of the palm knob 88, for example in a fashion similar to that discussed above with respect to FIG. 7, to form a friction fit sufficient to retain the palm knob 88 in connection with connector 20 during use.

Referring to FIGS. 31-36 the handle part 12 may comprise one or more slings 12A. A sling 12A may have a structure suitable to permit operation of hair cutting part 22 (not shown) on hard-to-reach areas using two hands on opposite ends or parts of the handle part 12 to simultaneously apply tension through the sling 12A and bring the hair cutting part 22 into contact with the target area. A sling 12A may be structured such that hair cutting part 22 attaches to the sling 12A at an intermediate position, for example a central position, between opposed handle ends and of the sling, or the hair cutting part 22 may be connected to ends of a pair of slings 12A as shown. Each of the opposed handle or tail ends may be shaped or oriented to form a respective hand grip to facilitate the application of tension in the sling 12A by a user 80 who grips and pulls opposed handle ends with respective hands of the user 80. The sling 12A may form a band. The sling 12A may form a pair of tethers, for example that extend in opposed directions. The sling 12A may be formed by a chain, rope, cable, sheet, tether or other part with suitable properties. The sling 12A may or may have a loop.

Referring to FIGS. 31-36 the sling 12A or slings 12A may be structured to connect to the reversible connector 20 in a suitable fashion. The reversible connector 20 may have one or more sling connectors 124. Each sling connector 124 may be mounted at or near the sides or side edges 64 of the base claw 58 (or the top claw 48). The sling connectors 124 may comprise one or more loops 126 or channels for receiving the sling 12A or each sling end 12B as shown. Each sling connector 124 may comprise a sling mounting pin 128. The mounting pin 128 may allow the sling 12A to be reversibly secured to the ends 12B of each sling 12A to permit the attachment and detachment of the sling 12A, for example if passed through a corresponding aperture or pin receiver 129 in the sling 124.

Referring to FIGS. 30 and 37-39, the elongate handle part 12 may be adapted to hang or secure to a wall, for example via a hole (such as eyelet 142) or aperture. In the example shown, the eyelet 142 or other mounting part (such as a hook, loop, or pin) may be located at a suitable part of the handle part 12, for example at the tail end 17 of the handle part 12. In some cases, the handle part 12 may include a lanyard or strap, and in some cases, the lanyard or strap may be extendible and retractable, for example out of and into the shaft, respectively.

Referring to FIGS. 37-43, an embodiment of a combination of a handle part 12 with a reversible connector 20 are illustrated, in which the handle part 12 is formed of plural parts that may be combined to produce the handle part 12. The example shown may be beneficial for a molding process that requires no or fewer inserts than a mold that produces a monolithic handle part 12 with reversible connector. Referring to FIGS. 42 and 43, the example shown provides the handle part 12 in two separate halves 12′, 12″, each with a shaft portion 14′, 14″. Shaft portion 14′ may mount base claw 58, while shaft portion 14″ may mount top claw 48. One or more connectors, such as connectors 49 and 51 may be used to connect the portions 14′, 14″ together. In the example shown, the pairs of connectors 49′, and 49″, and the connectors 51′, 51″, may latch together, for example via a snap fit between corresponding pins and holes, in order to secure the plural parts of the handle part 12 together in the final configuration. Referring to FIGS. 18 and 37, the reversible connector 20 may be structured to perform the friction fit function while permitting access to various controls, such as buttons 45 of the hair cutting part 16, for example via corresponding windows or slots 47 that are oriented and shaped accordingly.

Referring to FIGS. 44-63, a further embodiment of a handle part 12 is illustrated, with a handle part 12 formed of plural parts connected together and switchable between deployed and stowed modes. The handle part 12 may incorporate a tail part 12C connected to pivot or articulate relative to a head part 12D, for example about a hinge 130. The hinge 130 may be formed by a suitable structure, such as by a pin 130A mounted within pin receiver 130B, which might include one or more pin slots as shown. The parts of the handle part 12 may be lockable in one or both the stowed and deployed configurations. In the example shown, a locking mechanism may be defined by a latch 133A and catch 133B mechanism. The latch 133A may form a depressible button 132, such as a cantilever extended from tail part 12C, such that inward pressure on button 132 pushes the latch 133A out of engagement with the strike or catch 133B. The latch 133A and button 132 may be biased to engage, for example as shown where the button 132 forms a living hinge extended from tail handle part 12C. Referring to FIG. 48, when in the stowed configuration, the parts 12C and 12D may fold at least partially over themselves, reducing the footprint of the handle part 12. The handle part 12 may be structured in different forms, for example with three or more pivotally connected parts, or parts that can be separated and/or combined.

Referring to FIGS. 44-63, the handle part 12 may include a connector 134 for permitting the reversible connector 20 and handle shaft 14 to be provided as independent parts that are combinable together to provide the operating structure of the handle part 12. The structure shown may be advantageous for molding the various parts of the device, for example by separately molding the reversible connector 20 and parts of the handle part 12, which are then assembled in use. In the example shown, the connector 134 includes a male part 134A, a female part 134E structured to receive the male part 134A, and a retainer part 134B to secure the parts 134A and 134E together. In the example shown, the male part 134A has a stem 134A-1 that projects narrowly from the reversible connector 20 and widens into a lateral flange 134 or ridge. In some cases the male part 134A may have other shapes, such as a ball shape in the case of a ball and socket connection. The handle shaft 14, in this case the head end 16 of the handle part 12, may define the female part 134E, which has a relatively narrow stem receiver 134E-2 that widens into flange receiver 134E-1. In use, the male and female parts 134A and 134E may be structured to prevent the pullout of the male part 134A in an axial direction from the female part 134E. In the example shown, the male part 134A is mounted into the female part 134E by a lateral movement (perpendicular to an axis of the handle part 12) into a lateral mouth defined by the female part 134E. Once coupled together, a retainer part 134B, such as a clip or cap as shown, may be secured to the head end 16 of the shaft 14 to cover the lateral mouth and prevent removal of the male part 134A from the female part 134E. One or more fasteners 134C may be used to secure the retainer part 134B to the handle part 12, for example by passing through aligned apertures 135, 136 of the retainer part 134B and handle part 12, respectively. Each aperture, such as apertures 135, may include a bore 135A, which may widen to define a head receiving slot 135B to countersink the fastener head below or at a plane defined by the exterior surfaces of the retainer part 134B. The parts of the device 10 may be secured together by suitable mechanisms, such as one or more of fasteners, friction fitting, latches, sonic welding, adhesive, molding, and others. The retainer part 134B may have other suitable parts, such as a lip flange 134F-1 defined on a bottom face 134H opposite a top face 134J, between front and rear ends 134H and 134J, respectively.

Elongate handle part 12 may comprise one or more hand grip parts, such as textured surfaces with ridges or other friction-increasing elements, to increase grip and comfort. Elongate handle part 12 may comprise a shaft, which may be straight, curved, or both. Elongate handle part 12 may be used to reach and cut hair on areas of the body other than the back or legs, such as the buttocks, and head. Elongate handle part 12 may be length adjustable, for example telescopic, for further example to accommodate backs of different sizes. In one example, the handle part 12 is able to be set to a desired length and locked into place, for example so the user may select a shorter length for reaching areas that are slightly out of reach, and a longer length for reaching areas that are relatively further out of reach. Elongate handle part 12 may comprise an on/off switch, for example that is electrically connected to hair cutting part 22 or at a suitable location on handle part 12. Shaver head may have a shaver housing that forms a handle for holding the shaver which grips the shaver ergonomically. The handle part 12 and hair cutting part 22 may mate with one another via a suitable mechanism, for example a press fit, a latch, threading, magnets, fasteners, tethers, or other connection mechanisms. In some cases, both the reversible connector 20 and handle part 12 define respective hand grips.

Referring to FIGS. 75-82, embodiments of a hair cutting device 10 are illustrated that have a variety of unique features. The device 10 may be structured to retain a balancing weight part 170 (FIGS. 77 and 80) in use. The elongate member such as shaft 14 may mount or contain a balancing weight part 170 that has a relatively higher weight density, for example is relatively heavier, than the elongate member. For example, the weight part 170 may be constructed with metal, while the handle part 12 is constructed with plastic. The weight part 170 may be positioned at a suitable point along an axis 105 (FIG. 79) of the handle part 12 to shift the center of gravity of the device 10 to at or near (or at the least closer to) a longitudinal center of the device 10 when the device 10 mounts the hair cutting part (not shown). Without any counterbalancing, the hair cutting part may otherwise form a relatively heavier part of the device 10 than the handle part, and may shift the center of gravity toward the hair cutting part, creating an imbalance that can be corrected by at least partially balancing the weight along the axis 105 of the device 10. The weight part, such as an insert or bar as shown, may be retained by a suitable mechanism, such as being retained within a weight-part-receiving cavity 168 within the shaft 14, for example at or near the tail grip end 17 of the handle part 14.

Referring to FIGS. 75 and 75A, the palm knob 88 and the palm-knob-receiving cavity 46 may be structured to be keyed one to the other. For example, the rear part or end surface 88C of the palm knob 88 and the rear part or rear end 20B of the palm-knob-receiving cavity 46 may define cooperating male and female key parts, such as key 182 and key slot 180, respectively, that engage one another when the palm knob 88 is within the palm-knob-receiving cavity 46 in use. In some cases, plural male and female parts are used. The orientation of parts may be reversed from what is shown, such that the key 182 and key slot 180 are on the cavity 46 and knob 88, respectively. The use of a keyed engagement may mate or spline the parts together to avoid rotation, to lock the parts together, and/or to ensure that a user only uses a particular shape of hair cutting part 22 with device 10.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims. The use of top or bottom or base or lateral or up or down or other directional language is understood to be relative and not defined with respect to the surface of the Earth or the direction of gravitational acceleration unless context dictates otherwise.

1. A hair cutting device for a hair cutting part, the hair cutting part having a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, the multi-directional motorized blade being configured to cut hair while being advanced in any direction of skin travel within a 360-degree range of direction of skin travel, the body hair cutting device comprising: a handle part with an elongate member and a reversible connector on the elongate member, the handle part being sized to permit a user to remotely manipulate the hair cutting part in use into contact with all areas of a back and legs of the user; and the reversible connector having a base pincer claw and a top pincer claw collectively shaped and structured to grip in use both the base part and a palm grip top surface, respectively, of the palm knob to at least partially enclose the palm knob within a palm-knob-receiving cavity defined between the base and top pincer claws, with the neck received in use within a neck opening defined in the base pincer claw.

2. The hair cutting device of claim 1 in which respective terminal front tips of the base and top pincer claws are spaced to define a palm-knob-receiving mouth defining a lateral entry axis for the hair cutting part to enter and exit the palm-knob-receiving cavity.

3. The hair cutting device of claim 2 in which a respective terminal front tip of the base pincer claw and a respective terminal front tip of the top pincer claw curl inward toward one another to retain a front part of the palm knob between the respective front tips and a rear end of the palm-knob-receiving cavity.

4. The hair cutting device of claim 3 in which the respective terminal front tip of the base pincer claw and the respective terminal front tip of the top pincer claw collectively form a C-shape in cross-section.

5. The hair cutting device of claim 2 in which the reversible connector is structured to snap fit to and quick release from the palm knob.

6. The hair cutting device of claim 5 in which one or both of the base pincer claw and the top pincer claw form resilient cantilever snap fits.

7. The hair cutting device of claim 1 in which the reversible connector is structured to friction fit to the palm knob.

8. The hair cutting device of claim 7 in which a rear part of the palm-knob-receiving cavity is shaped to conform to a rear part of the palm knob to form the friction fit therebetween.

9. The hair cutting device of claim 8 in which the rear part of the palm knob is tapered to have decreasing lateral dimensions with decreasing distance to a rear end of the palm knob, and the rear part of the palm-knob-receiving cavity that conforms to the rear part of the palm knob is tapered to have increasing lateral dimensions with increasing distance from the rear end of the palm-knob-receiving cavity.

10. The hair cutting device of claim 8 in which the rear part of the palm knob and the rear part of the palm-knob-receiving cavity define cooperating male and female key parts that engage when the palm knob is within the palm-knob-receiving cavity.

11. The hair cutting device of claim 1 in which one or both of the base pincer claw and top pincer claw have opposed side edges that curl inward toward one another to retain opposed sides of the palm knob within the palm-knob-receiving cavity.

12. The hair cutting device of claim 11 in which both of the base pincer claw and top pincer claw have opposed side edges that curl inward.

13. The hair cutting device of claim 1 in which the base pincer claw and the top pincer claw define a base cupping member and a top cupping member, respectively, that collectively define the palm-knob-receiving cavity.

14. The hair cutting device of claim 1 in which the base pincer claw comprises opposed side fingers that are separated laterally to define the neck opening as a neck slot, and whose respective finger tips are separated to define a neck-receiving mouth to the neck slot.

15. The hair cutting device of claim 1 in which the neck opening is structured to encircle and form a closed path about the neck in use.

16. The hair cutting device of claim 1 in which the base pincer claw is structured to grip the neck about the neck slot.

17. The hair cutting device of claim 1 in which opposed sets of side edges of each of the base and top pincer claws are separated between the base and top pincer claws to define finger access slots to opposed sides of the palm knob.

18. The hair cutting device of claim 1 in which the elongate member mounts or contains a balancing weight part that has a relatively higher weight density than the elongate member.

19. The hair cutting device of claim 1 in which the elongate member comprises an elongate shaft with the reversible connector mounted at a head end of the elongate shaft.

20. The hair cutting device of claim 19 in which the elongate shaft has a length of at least one foot.

21. The hair cutting device of claim 1 in which the elongate member comprises a sling.

22. The hair cutting device of claim 1 further comprising the hair cutting part, with the palm knob at least partially enclosed within the palm-knob-receiving cavity.

23. The hair cutting device of claim 22 in which the multi-directional motorized blade is connected to pivot relative to one or more of the neck, the palm knob, or the handle part.

24. A method comprising operating the hair cutting device of claim 22 to cut hair on a body of a user.

25. A method comprising operating a handle part to manipulate a hair cutting part into contact with a user, in which: the hair cutting part has a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, in which during operating the multi-directional motorized blade cuts hair while being advanced in any direction of skin travel within a 360-degree range of direction of skin travel; and the handle part has an elongate member and a reversible connector on the elongate member, in which during operating the handle part permits the user to remotely manipulate the hair cutting part into contact with all areas of a back and legs of the user; and the reversible connector having a base pincer claw and a top pincer claw collectively shaped and structured to grip both the base part and a palm grip top surface, respectively, of the palm knob, to at least partially enclose the palm knob within a palm-knob-receiving cavity defined between the base and top pincer claws, with the neck received within a neck opening defined in the base pincer claw.

26. The method of claim 25 further comprising connecting the hair cutting part to the reversible connector by inserting the palm knob through a palm-knob-receiving mouth defined by the base and top pincer claws into the palm-knob-receiving cavity.

27. The method of claim 26 in which connecting comprises latching the base and top pincer claws to the palm knob by snap fit.

28. The method of claim 26 in which connecting comprises connecting the base and top pincer claws to the palm knob by friction fit.

29. The method of claim 26 further comprising disconnecting the hair cutting part to the reversible connector by opening the base and top pincer claws and retracting the palm knob through the palm-knob-receiving mouth from the palm-knob-receiving cavity.

30. The method of claim 29 in which disconnecting comprises retracting the palm knob through the palm-knob-receiving mouth from the palm-knob-receiving cavity with a force that is greater than a force required to insert the palm knob through the palm-knob-receiving mouth into gripping contact with the palm-knob-receiving cavity

31. A hair cutting device comprising: a hair cutting part with a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, the multi-directional motorized blade being configured to cut hair while being advanced in any direction of skin travel within a 360-degree range of direction of skin travel; and a handle part with an elongate member and a reversible connector on the elongate member, the handle part being sized to permit a user to remotely manipulate the hair cutting part into contact with all areas of a back and legs of the user; and the reversible connector having pincer claws collectively shaped and structured to friction fit to the palm knob to at least partially enclose the palm knob within a palm-knob-receiving cavity defined between the pincer claws, in which a rear part of the palm-knob-receiving cavity is shaped to conform to a rear part of the palm knob to form the friction fit therebetween.

32. The hair cutting device of claim 31 in which the rear part of the palm knob is tapered to have decreasing lateral dimensions with decreasing distance to a rear end of the palm knob, and the rear part of the palm-knob-receiving cavity that conforms to the rear part of the palm knob is tapered to have increasing lateral dimensions with increasing distance from the rear end of the palm-knob-receiving cavity.

33. A method comprising operating a handle part to manipulate a hair cutting part into contact with a user, in which: the hair cutting part has a palm knob and a multi-directional motorized blade, the hair cutting part being shaped, in a direction from a palm grip top end to a hair cutting base end of the hair cutting part, to narrow at a base part of the palm knob to define a neck and then widen at a base part of the neck to the multi-directional motorized blade, in which during operating the multi-directional motorized blade cuts hair while being advanced in any direction of skin travel within a 360-degree range of direction of skin travel; and the handle part has an elongate member and a reversible connector on the elongate member, in which during operating the handle part permits the user to remotely manipulate the hair cutting part into contact with all areas of a back and legs of the user; and the reversible connector having pincer claws collectively shaped and structured to friction fit to the palm knob to at least partially enclose the palm knob within a palm-knob-receiving cavity defined between the pincer claws, in which a rear part of the palm-knob-receiving cavity is shaped to conform to a rear part of the palm knob to form the friction fit therebetween.
